(19) United States
(12) Patent Application Publication
(10) Pub. No.: US 2012/0096087 A1
(43) Pub. Date: Apr. 19, 2012

(54) SYSTEM AND METHOD FOR GENERATING PUBLICATIONS VIA COLLABORATION

(76) Inventor: Felice Curcelli, Saratoga, CA (US)

(21) Appl. No.: 13/088,638

(22) Filed: Apr. 18, 2011

Related U.S. Application Data
(60) Provisional application No. 61/342,951, filed on Apr. 21, 2010.

(51) Int. Cl. G06F 15/16

(52) U.S. Cl. 709/204

(57) ABSTRACT

The system and method herein described allows home cooks and professional chefs with basic computer skills create recipes with photo slideshows and videos, collect and organize recipes in electronic cookbooks that can be published and sold as eBooks. The new process incorporates methods for computing calories, nutritional facts and food group servings of recipes, and comparing said nutrients and food group servings to recommended daily allowances.

### CROSS REFERENCE TO RELATED APPLICATIONS

This application claims the benefit of U.S. Provisional Patent Application No. 61/342,951 Filed Apr. 21, 2010, the entire disclosure of which is incorporated herein by reference.

### FIELD OF THE INVENTION

The present invention generally relates to the automation of generating eBooks. Specifically, this invention relates to a system and method for allowing multiple chefs, without any particular knowledge of publishing or computer systems, to collaborate over one or more networks and generate a cookbook. The system and methods described herein also incorporate processes for computing caloric and other nutritional information related to one or more recipes contained within the cookbook.

### BACKGROUND OF THE INVENTION

The current art includes some aspect of this invention but none of the current art sees the consumers as publishers in the way this invention does.

The advent of the web and mobile apps has brought consumers plenty of data and information on how to start on a balanced and healthy diet to control weight gains or to lose weight. Recommendations on calorie intake based on age, sex, activity levels are widely available. Information and apps are also available to help consumers track food consumption and monitor calories based on actual activity for a given day. These sites focus on journaling of ingredients and foods consumed during the day, not on recipes that can be assembled in cookbooks and meal plans and that can actually help consumers make the leap and become cooks of their own food.

Some web sites provide nutrition information on user's own recipes but these web sites fail to provide an easy to use process and provide the nutritional information of recipes as typically found on food nutrition labels.

There are printed books and magazines that have made the leap into the online web and provide nutritional information on recipes. These attempts, however, fail to provide the cook or group of cooks the ability to create their own online cookbooks.

Existing eBooks of recipes exist but these are simply a translation of format from paper and fail to give the cooks the ability to make decisions when creating recipes that take into account caloric and nutritional facts or family size.

The USDA provides an electronic database that allows consumers, food industry operators, or nutritionists to “compute” the caloric or nutrient content for thousand of ingredients and foods. This electronic data is used and augmented in some cases but the presentation always focuses on ingredients rather than on what the user consumes, i.e. a recipe of ingredients prepared according to a particular cooking method, and fails to incorporate the other important aspect of the guidelines, the USDA food pyramid.

Following even simple dietary guidelines it's not an easy task for the majority of consumers to deal on their own. Therefore many consumers seek the help of a dietician or follow a specific diet that suggests specific recipes or food to eat and quantities based on age and activity levels.

While dieticians or specific diets serve a role for a given section of the population or for consumers with a given condition, the obesity problem affecting the new generations and modern societies tells that an alternative simpler method should be sought to help consumers help themselves follow more balanced diets using recipes and food they love and eat daily.

Lastly, searching for recipes online has become one of the most common activities of web users. However, there is a lack of standardization of how to search for information, e.g. when searching for a recipe a visitor should only get recipes with matching ingredients or matching keywords in recipe title and that's not the case. Also, the information is mostly presented in ways that favors advertising and not focusing, if at all, on the recipes' content and in particular nutritional aspect of the recipes.

In summary, there is no known art that allows home and professional cooks with limited computer skills to gather own and favorite recipes in a electronic cookbook format, i.e. online cookbooks, that makes them publishers and also allows them to leverage with no effort on their part on a compute method that computes and visualizes easy-to-apply nutritional information and guidance on their recipes, a workflow method that allows them to invite friends in the creation of the cookbooks, a conversion method that automatically converts the online cookbooks into an eBook format and that can be sold through established online stores, and a new interactivity method that gives the reader of the cookbook or eBook the ability to personalize recipes and experience, e.g. modify the amount of ingredients in recipes for a different number of servings than recipes were created for, or view recipe's nutrition information compared to own personal profile.

Therefore, there is a need in the art for a system and method for allowing home and professional cooks with limited computer skills to perform the aforementioned tasks. These and other features and advantages of the present invention will be explained and will become obvious to one skilled in the art through the summary of the invention that follows.

### SUMMARY OF THE INVENTION

Accordingly, it is an object of the present invention to allow users of a computer, smart-phone, tablet, mobile device or other computing device to create, collaborate, and publish recipes and electronic online cookbooks that provide easy to apply nutritional information and guidance. This system and methods described herein give any cook with basic computer skills the ability to collect recipes and publish them in online cookbooks and eBooks, without requiring knowledge of eBook publishing or skills in book layout.

According to an embodiment of the present invention, the new process helps the cook, professional chef, or groups of cooks and chefs, monetize their efforts through the publishing of their recipes and eBooks by setting prices or accepting donations.

According to an embodiment of the present invention, a consumer oriented approach and algorithmic intelligence of the invention presents nutritional facts in an aggregated way which makes it easier to incorporate nutritional guidelines in home and professional cooking

According to an embodiment of the present invention, the systems and methods herein described help consumers connect the dots between dissimilar guidelines: the USDA Recommended Daily Allowances for macro-nutrients and micro-nutrients and the USDA Food Pyramid recommendation providing guidance on amount and servings of food groups.

According to an embodiment of the present invention, a compute method implementing a nutritional facts computation and food group servings computation helps a cook understand the cause and effect of choosing certain ingredients versus others and their quantity.

According to an embodiment of the present invention, a compute method implements a Rating associated with recipes and food journals. The Cookiti Apples Rating was developed to correspond with the latest Dietary Guidelines for Americans released in 2010. The Guidelines promote consumption of a variety of nutrient-dense foods and beverages from the basic food groups and encourage foods that limit intake of saturated and trans fat, cholesterol, added sugars and salt while promoting an increase in fiber rich choices. The Guidelines encourage a balanced diet rich in fruits and vegetables, lean protein, low fat dairy products, grains, beans, peas and legumes at the appropriate calorie level.

According to an embodiment of the present invention, the Cookiti Apple Rating gives cooks and viewers of their recipes immediate feedback on how a recipe meets said guidelines and helps them promote good health.

According to an embodiment of the present invention, suggested implementations of the system and methods described herein incorporate modern user experience techniques to complete tasks simply, intuitively, and quickly. The user experience emphasizes cleanness of the user interface to help users navigate and find content and nutritional facts very easily and quickly.

According to an embodiment of the present invention, the systems and methods herein described may be implemented through a web-based service that allows a publisher-consumer home cooks collaborate with family members and friends to create cook books for publishing on the web and/or to eBook stores.

According to an embodiment of the present invention, the systems and methods herein described may be implemented, for example, via a ‘web site’. In this manner, a company can help raise nutritional awareness of consumers by presenting computed nutrition facts and recommended dietary allowances as a focal point of the user experience, without being too intrusive.

According to an embodiment of the present invention, there are at least five embodiments of the invention that may build on each other and work together:
1) Give users ability to add ‘common name’ ingredients to a list and automatically compute the aggregated nutritional facts and food group servings, visually chart and compare each nutrient and food group to the recommended daily allowances and food group recommendation.
2) Give users ability to save list of ingredients as recipes, specifying a cooking method, optional multi-media visual content such as photo slide-shows and videos, and cooking instructions, then save recipe with corresponding nutritional facts and food group servings. The consumer viewing a recipe of another chef would view the nutritional facts saved in recipe compared to the recommended nutrient and food group allowances based on own personal profile.
3) Give users the ability to search recipes, own recipes and public recipes shared by other chefs, sort results according to criteria that emphasize balanced diets and good nutrients, such as good fats, good carbs, and good proteins, and give users ability to add other chef's recipes as favorite recipes to own recipe box.
4) Give chefs with no knowledge of web or eBook publishing, nor book layout skills, the ability to create and publish eBooks of recipes in few simple steps: selecting one of pre-built templates for the book cover and one for recipe pages; selecting which table of contents and book navigation methods to generate; optionally sharing the cookbook with friends and family by allowing each one to contribute to the cookbook with own recipes or favorite recipes; setting a price or accept donations; then choosing the distribution methods, i.e. through a web site or online eBook stores. The process automatically creates the specified tables of content, navigation to specific sections, plus incorporates interactive features and multi-media support, such as video streaming and annotations. The conversion method generates the standard ePub format for eBook distribution and retains the interactivity of the corresponding online cookbook.
5) Give users the ability to aggregate recipes and journals in meal plans and grocery lists, as every cook daily activity includes the planning of meals and shopping for food. One distinguishing factor of the meal planning embodiment is to allow cooks to leverage on their existing recipes to plan their daily meals very simply. The added benefit to the cooks are the computed daily averages of nutrition facts and food group servings as well as the presentation of said facts and servings sorted by recipe and by ingredient to help cooks narrow on the dominating recipes and ingredients, weaknesses and excesses of the meal plan, thus help them make adjustments to meet the provided guidance.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 shows how remote users at computers, mobile devices or partner web sites interact with the systems and methods described herein and each of the applications embodied by the new service;

FIG. 2 shows a flow-chart of a typical interaction with a new service implementing the invention, in accordance with an embodiment of the present invention, where a user creates a recipe or food journal from a list of ingredients;

FIG. 3 shows algorithms used to compute nutritional facts, in accordance with an embodiment of the present invention;

FIG. 4 shows a flow-chart of an algorithm, in accordance with an embodiment of the present invention, used to compute the Cookiti Apples Rating associated with recipes and food journals;

FIG. 5 shows an algorithm to compare and display nutritional facts and food group servings, in accordance with an embodiment of the present invention;

FIG. 6A shows the representation of the Cookiti Apples Rating, in accordance with an embodiment of the present invention;

FIG. 6B shows a presentation of a user's Primary Nutrition Facts compared to the user's own Recommended Daily Allowances, in accordance with an embodiment of the present invention;

FIG. 6C shows a combined representation of Nutrition Facts and Food Group servings compared to user's own RDA, in accordance with an embodiment of the present invention;

FIG. 7 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 8 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 9 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 10 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 11 shows a flow-chart of a method in accordance with an embodiment of the present invention;

FIG. 12 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 13 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 14 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 15 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 16 shows an implementation of how a user at a remote computer or mobile device would interact with a web site or service, in accordance with an embodiment of the present invention, to let user create, search, sort recipes or journals, analyze their respective nutritional facts and food group servings, and compare them to recommendations based on personal profile;

FIG. 17 shows a flow-chart of a method used by co-authors to create, collaborate, and publish new cookbooks, in accordance with an embodiment of the present invention;

FIG. 17B shows data elements required to create the cookbook framework, in accordance with an embodiment of the present invention;

FIG. 17C shows options to share cookbook with public and other members, in accordance with an embodiment of the present invention;

FIG. 17D shows a cookbook organizer for adding and sorting recipes to online cookbook, in accordance with an embodiment of the present invention;

FIG. 17E shows a diagram of how a table of contents is created, in accordance with an embodiment of the present invention;

FIG. 17F shows a flow-chart of a user's actions supported in navigating a cookbook, in accordance with an embodiment of the present invention;

FIG. 18 shows options for publishing a cookbook as an eBook, in accordance with an embodiment of the present invention;

FIG. 19 shows a flow-chart of a convert method that transforms an online cookbook into an eBook, in accordance with an embodiment of the present invention;

FIG. 20 shows an implementation of how a user at a remote computer or mobile device would interact with a web site or service implementing the fourth embodiment of the invention, in accordance with an embodiment of the present invention;

FIG. 21 shows an implementation of how a user at a remote computer or mobile device would interact with a web site or service implementing the fourth embodiment of the invention, in accordance with an embodiment of the present invention;

FIG. 22 shows an implementation of how a user at a remote computer or mobile device would interact with a web site or service implementing the fourth embodiment of the invention, in accordance with an embodiment of the present invention;

FIG. 23 shows an implementation of how a user at a remote computer or mobile device would interact with a web site or service implementing the fourth embodiment of the invention, in accordance with an embodiment of the present invention;

FIG. 24 shows an implementation of how a user at a remote computer or mobile device would interact with a web site or service implementing the fourth embodiment of the invention, in accordance with an embodiment of the present invention;

FIG. 25 shows an implementation of how a user at a remote computer or mobile device would interact with a web site or service implementing the fourth embodiment of the invention, in accordance with an embodiment of the present invention;

FIG. 26A shows an example of an eBook generated in accordance with an embodiment of the present invention;

FIG. 26B shows an example of an eBook generated in accordance with an embodiment of the present invention;

FIG. 26C shows an example of an eBook generated in accordance with an embodiment of the present invention;

FIG. 26D shows an example of an eBook generated in accordance with an embodiment of the present invention;

FIG. 26E shows an example of an eBook generated in accordance with an embodiment of the present invention;

FIG. 26F shows an example of an eBook generated in accordance with an embodiment of the present invention;

FIG. 27 shows a one page monthly calendar used for cooks to create and analyze meal plans, in accordance with an embodiment of the present invention;

FIG. 28A shows a flow-chart for creating meal plans, in accordance with an embodiment of the present invention;

FIG. 28A shows an algorithm, in accordance with an embodiment of the present invention, used to compute, compare, and display daily average of nutritional facts compared to RDA;

FIG. 28B shows an algorithm, in accordance with an embodiment of the present invention, used to compute, compare, and display daily average of nutritional facts compared to RDA;

FIG. 28C shows a nutrients analysis tool in calendars, in accordance with an embodiment of the present invention;

FIG. 28D shows a nutrients analysis tool in calendars, in accordance with an embodiment of the present invention;

FIG. 29 shows an implementation of calendars, in accordance with an embodiment of the present invention;

FIG. 30 shows an implementation of calendars, in accordance with an embodiment of the present invention;

FIG. 31 shows an implementation of calendars, in accordance with an embodiment of the present invention;

FIG. 32 is a generalization of the fourth embodiment of the invention for co-authors to create, collaborate, and publish any eBook to web or eBook stores.

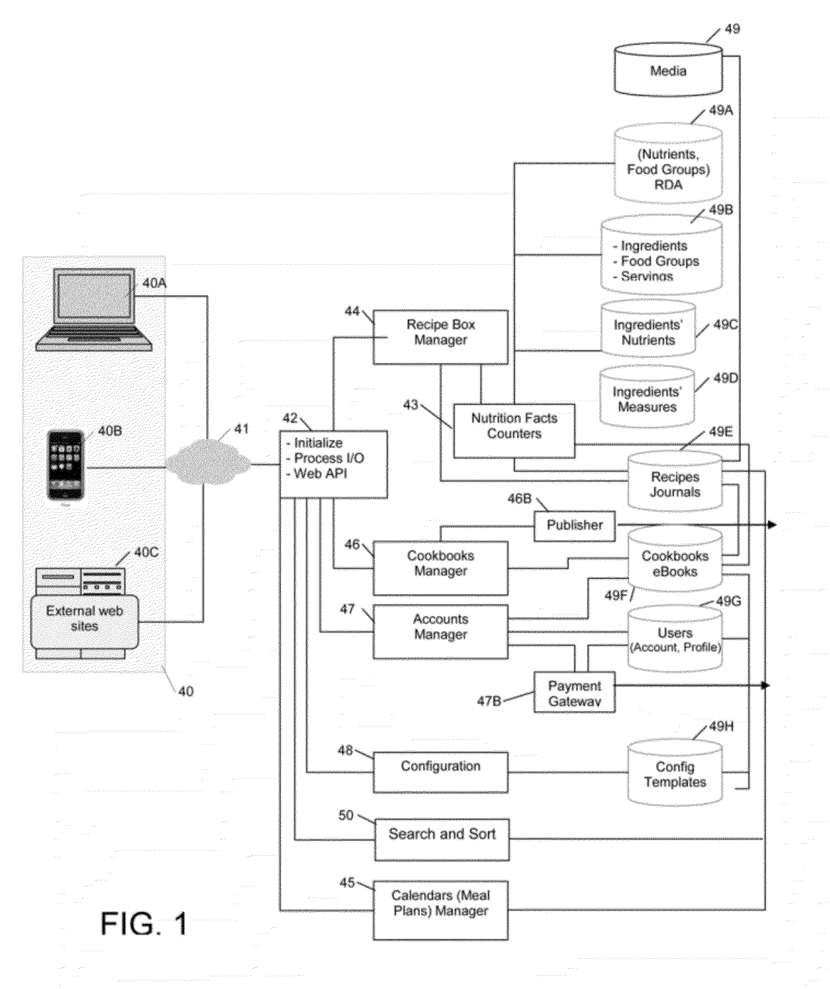

### DETAILED SPECIFICATION

According to an embodiment of the present invention, a user of a remote device 40, computer 40A or a smart phone 40B, or external web site 40C, can access a service implementing the invention through the internet 41.

According to an embodiment of the present invention, a method 42 is configured to read a user's profile 49G, if user is registered with the service, the system authenticates the user, initializes a session, and processes all input and output from and to users at remote devices 40A, 40B, and 40C. Users 40A would interact with method 42 through a web browser, user on a mobile device 40B would interact with a local app and local app would interact with method 42 through web-based REST-like API services. Partner web sites 40C would interact with method 42 through web-based REST-like API services.

According to an embodiment of the present invention, the method 42 initialization also determines, based on the user profile, the primary nutrition facts 96 of interest.

According to an embodiment of the present invention, a module 43 is comprised of one or more methods that allow users to create a list of ingredients from data store 49B, specify a quantity and a measure, retrieved from 49D, based on which it computes the list's Cookiti Apples Rating, nutritional facts and food groups servings based on ingredients' nutrient values in 49C.

According to an embodiment of the present invention, the one or more methods in module 43 compute and displays the rating, charts of nutrients and food groups, comparing each nutrient and food group to the user's recommended daily allowances and food group servings recommendation based on user profile in data store 49G. The Recommended Daily Allowances (RDA) are stored in data store 49A and are used to determine how do draw the nutrients and food group charts. The data stored in 49A includes the values for each nutrient as well as food group servings by age, sex, activity level, and body frame size.

According to an embodiment of the present invention, non-registered users may be provided limited access to the method 43 and are not able to create and store recipes 49E.

According to an embodiment of the present invention, a module to manage a Recipe Box 44 with methods that give users ability to save a list of ingredients created with method 43 as a recipe 49E, and search, sort, or remove said recipes. Save method in Recipe Box 44 automatically saves with recipes so created in recipe 49E their corresponding nutritional facts and food group servings computed with method 43.

According to an embodiment of the present invention, methods in Recipe Box 44 also rely on the Search and sort methods 50 to help users manage own recipes and find and add other users' recipes as favorite.

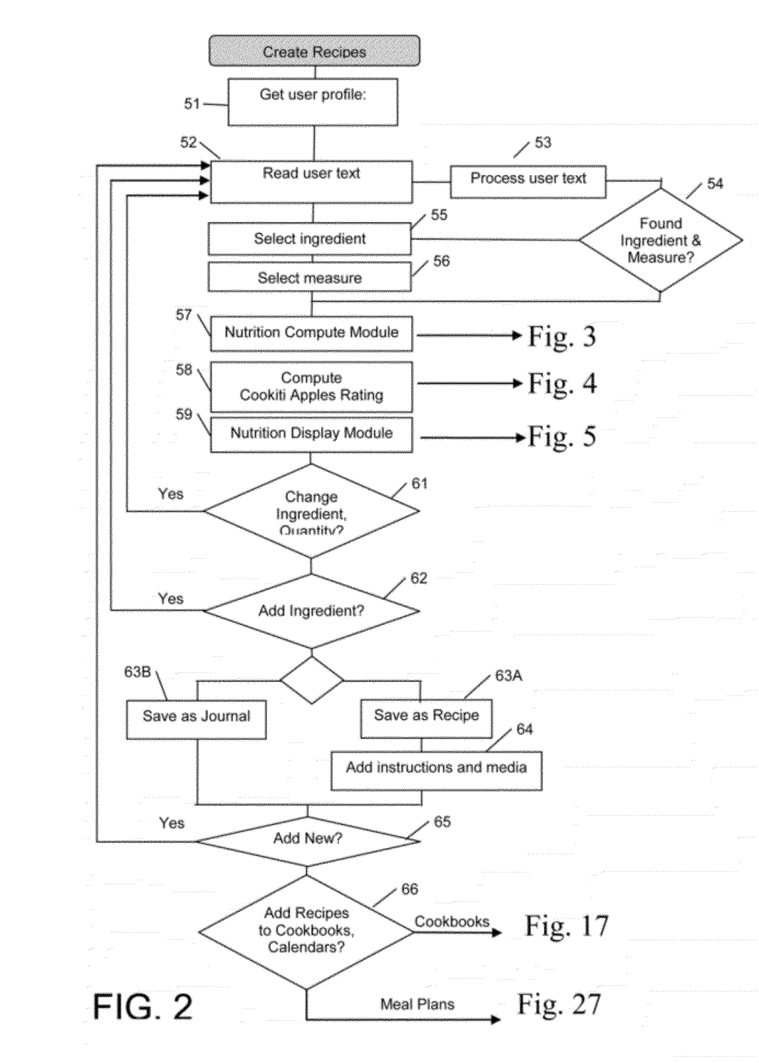

According to an embodiment of the present invention, methods 43 and 44 are detailed further in FIGS. 2-6 and described in the sections Nutritional Facts Counters and Recipe Box Manager, the 1^{st}, 2^{nd}, and 3^{rd} embodiments of the present invention.

According to an embodiment of the present invention, a module to create and manage Cookbooks 46 with methods that give users ability to create books of recipes, i.e. cookbooks in 49F, by choosing a name and a template from a set of predefined templates 49H. User can co-author books with registered friends in data store 49G by allowing each one to contribute to the cookbooks with own recipes. Navigation method in Cookbooks 46 creates table of contents and book navigation automatically; publish method 46B helps authors publish their cookbooks by choosing a distribution method using a publishing method, i.e. thru a web site or eBook stores.

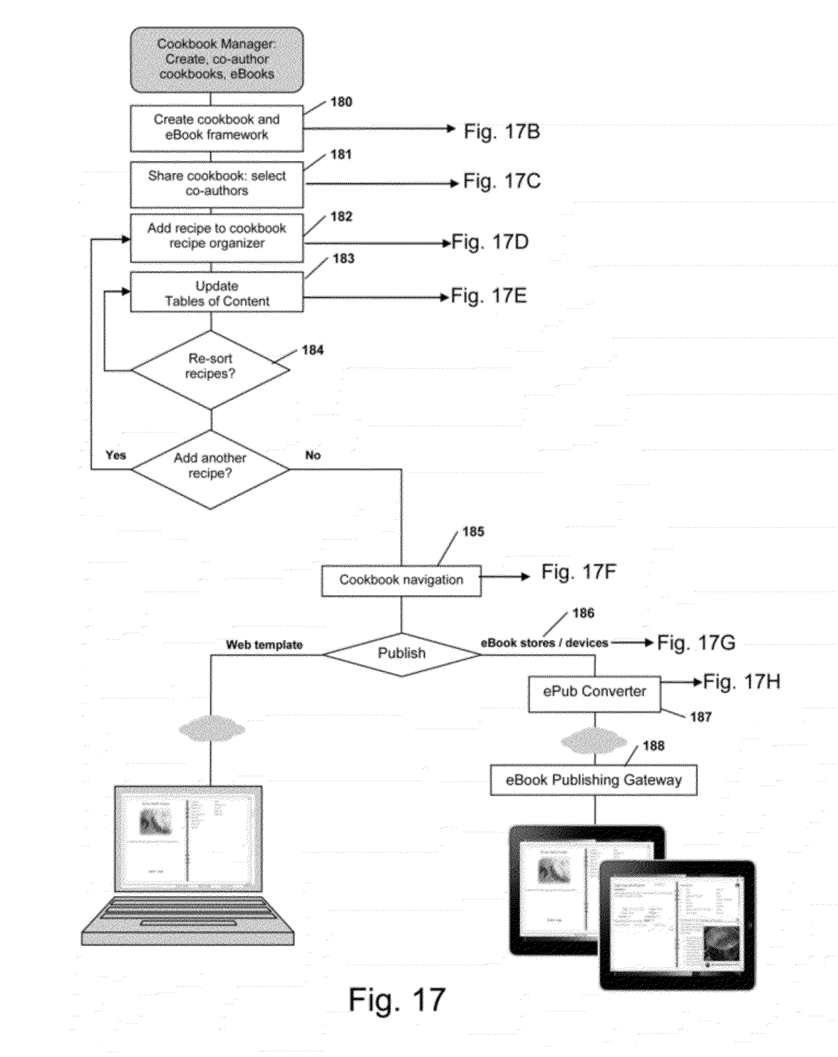

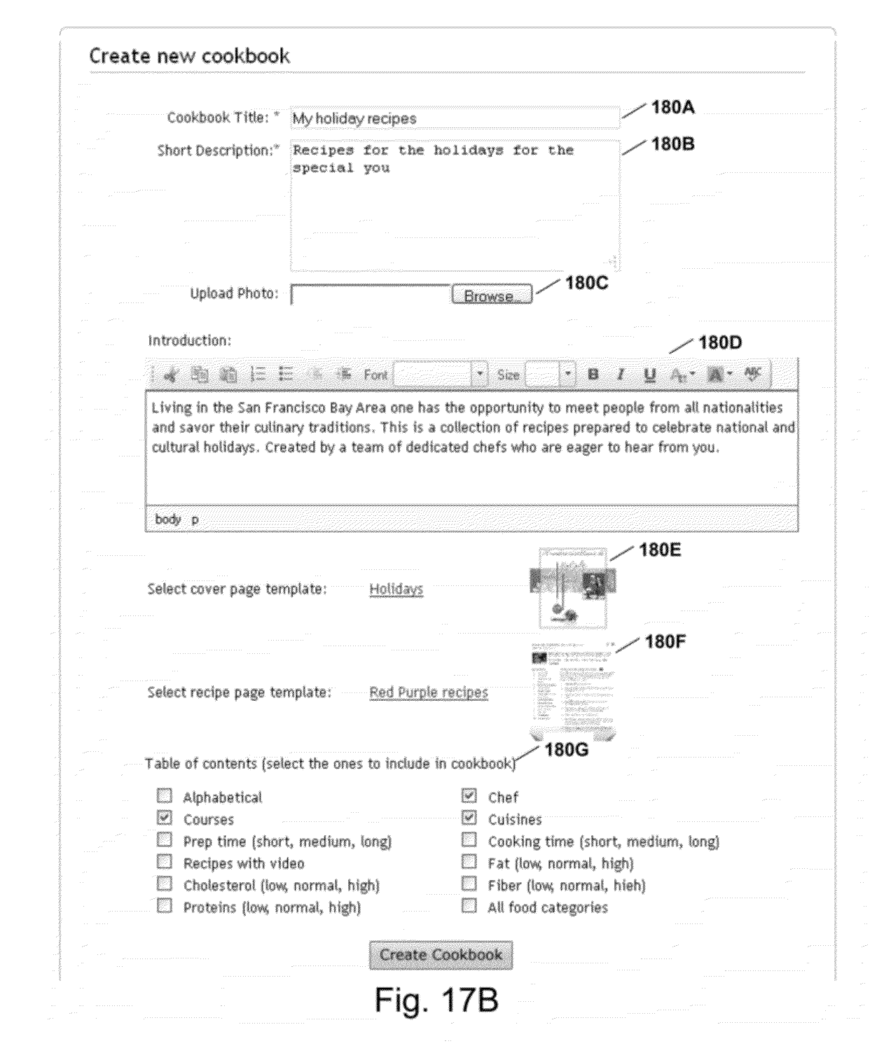

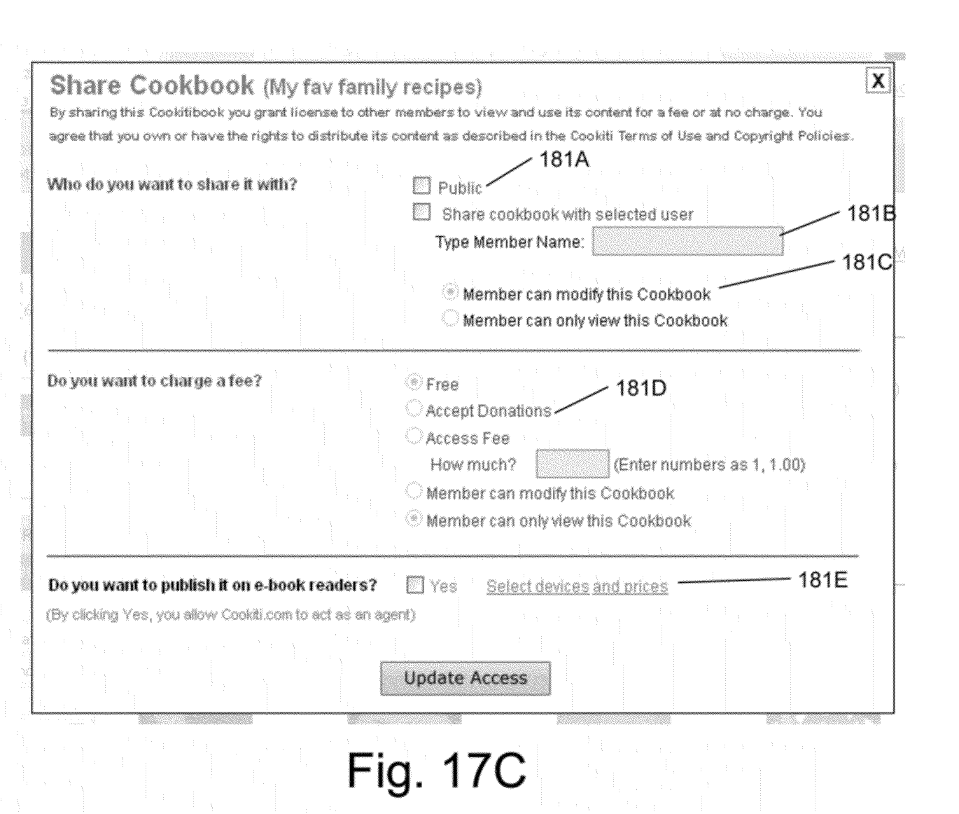

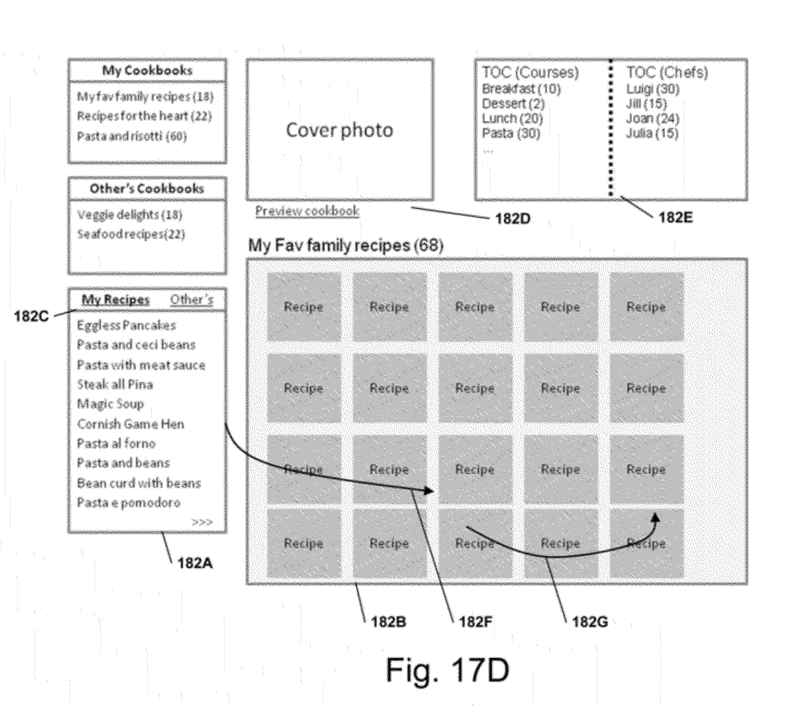

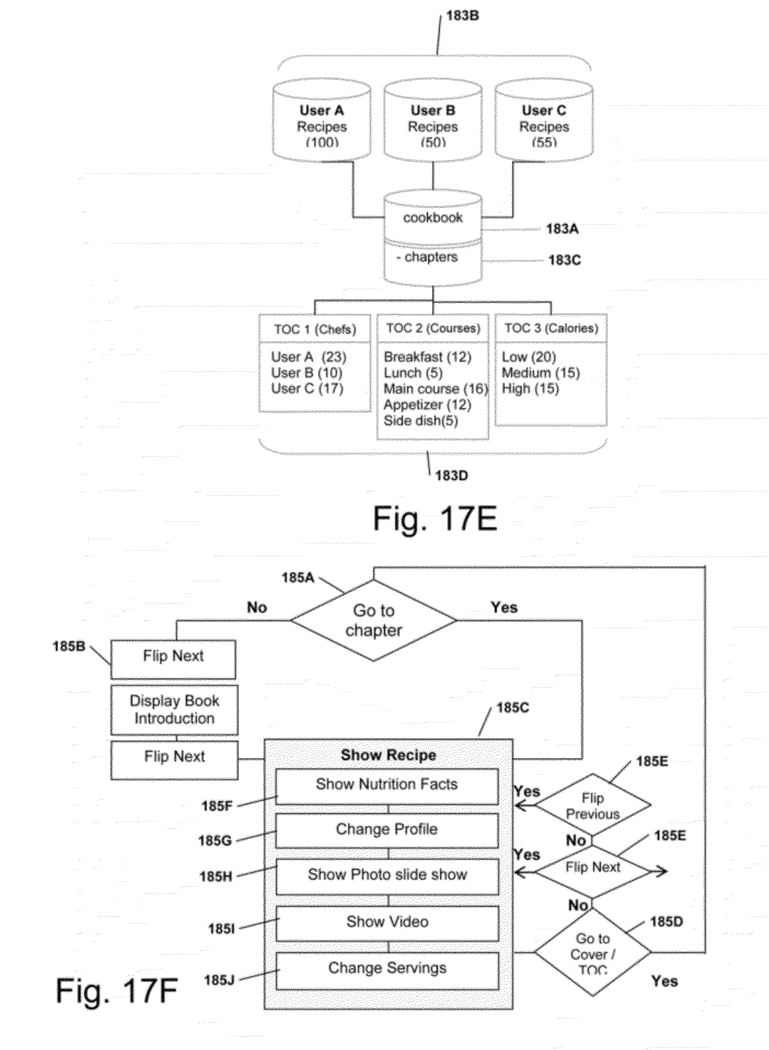

According to an embodiment of the present invention, the navigation method 46 and publish method 46B are detailed further in FIGS. 17-17F and described in the section Cookbooks Manager (co-authored interactive books of recipes), the fourth embodiment of the invention.

According to an embodiment of the present invention, a module to manage Calendars 45 with methods that give users ability to aggregate recipes and journals in meal plans, automatically compute daily and daily average of nutrients and calories and gives users ability to rearrange daily meal plans by dragging recipes to a different day.

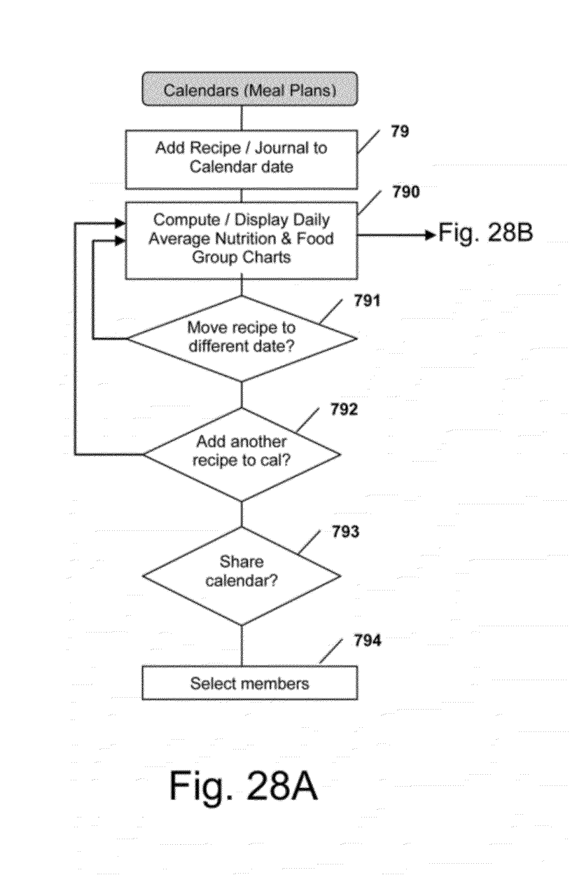

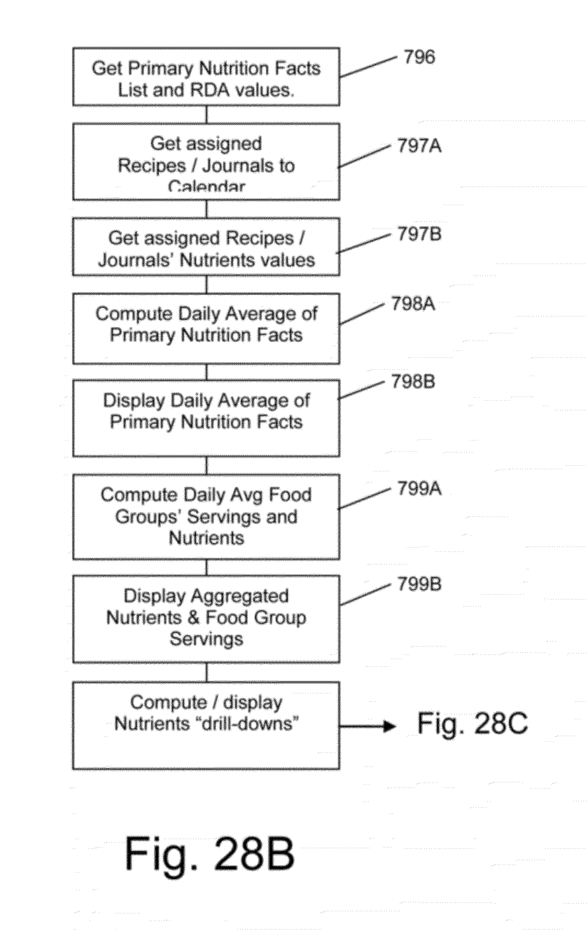

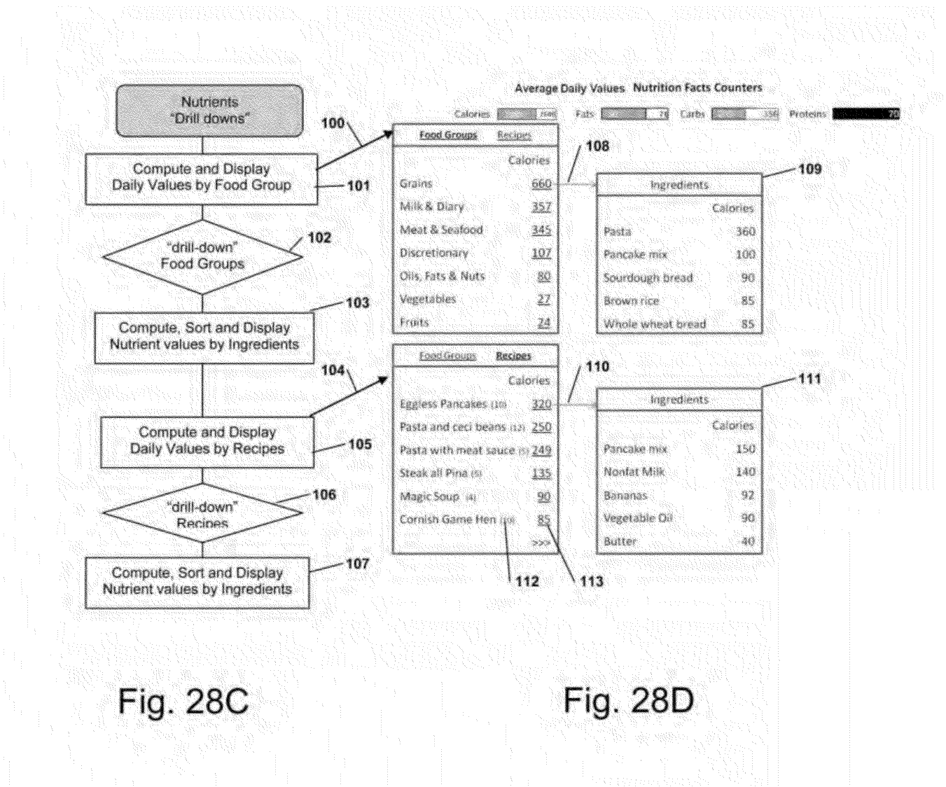

According to an embodiment of the present invention, the module to manage Calendars 45 is further detailed in FIGS. 28-28F and described in the section Calendars Manager Module (shared meal plans), the fifth embodiment of the invention.

Nutrition Facts Counters and Recipe Box

Step 51 of the process shown in FIG. 2 retrieves user personal profile and preferences, such as age, sex, activity level and body frame size, primary nutrition facts 96, default servings size for recipes 51, and default search preferences.

Step 52 allows user to enter free text to search for ingredients to add to a list. The method displays the matching list of ingredients 55 and the list is refined as user types; it then allows user to select a corresponding measure and quantity 56 of the ingredient.

The method may allows user to type measure and quantity along ingredient name in which case the method invokes the natural language processing method 53 to parse user text to extract ingredient name 55, quantity and measure 56.

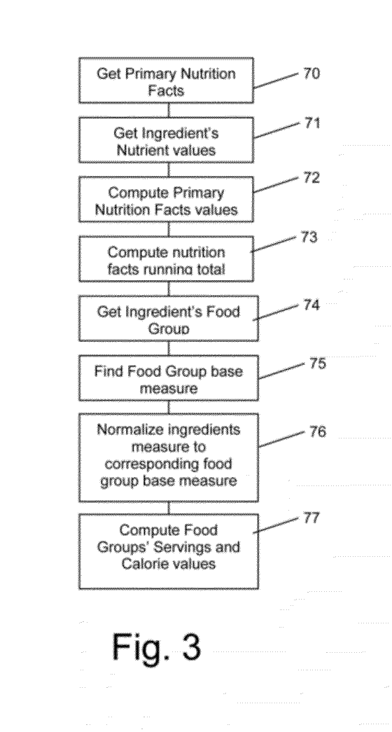

Based on ingredient's measure and quantity the process in FIG. 2 then invokes the Nutrition Compute Module 57 which is detailed in FIG. 3 to compute running total of nutrition facts, the primary nutrition facts, and the aggregated nutrients values and food group servings.

The Nutrition Compute Method

Method 70 in FIG. 3 retrieves the nutrient's values of the new ingredient from data store 49C.

The method 71 retrieves the ingredient's nutrient values, which are used by method 72 to compute the primary nutritional facts based on entered ingredient's quantity and measure. The method assumption is that all nutrient values 49A are stored based on quantities of 100 metric gram units of an ingredient. To compute the nutritional facts for the current ingredient's measure and quantity in list the method converts the specified measure and quantity to the equivalent metric gram units and pro-rates the ingredient's nutrient values stored in 49A.

The method 72 computes the aggregated total values of the primary nutrition facts and micro-nutrients in 73.

The method 74 computes the food group servings for the entered ingredients using the association of ingredients to food groups in data store 49B. To compute and compare the number of “servings” for entered ingredients to food group servings recommendation, the method finds first the food group base measure 75. This is for instance the measure “oz” for grains or meats or the measure “cup” for vegetables and milk food groups.

The method 76 then normalizes the ingredient's measure specified by the user to the base measure of the corresponding food group. All ingredients are assumed to have in data store 49D the corresponding base measure of the parent food group. In those cases where an ingredient has not been assigned the food group's base measure, the method will default to a pre-defined conversion value.

The method 77 then computes food group servings in both USDA food group recommendation measures as well as metric gram units and calorie values. The method converts the user selected ingredient measure and quantity to metric grams, and then back from metric grams to the base measure.

Cookiti Apples Rating Method

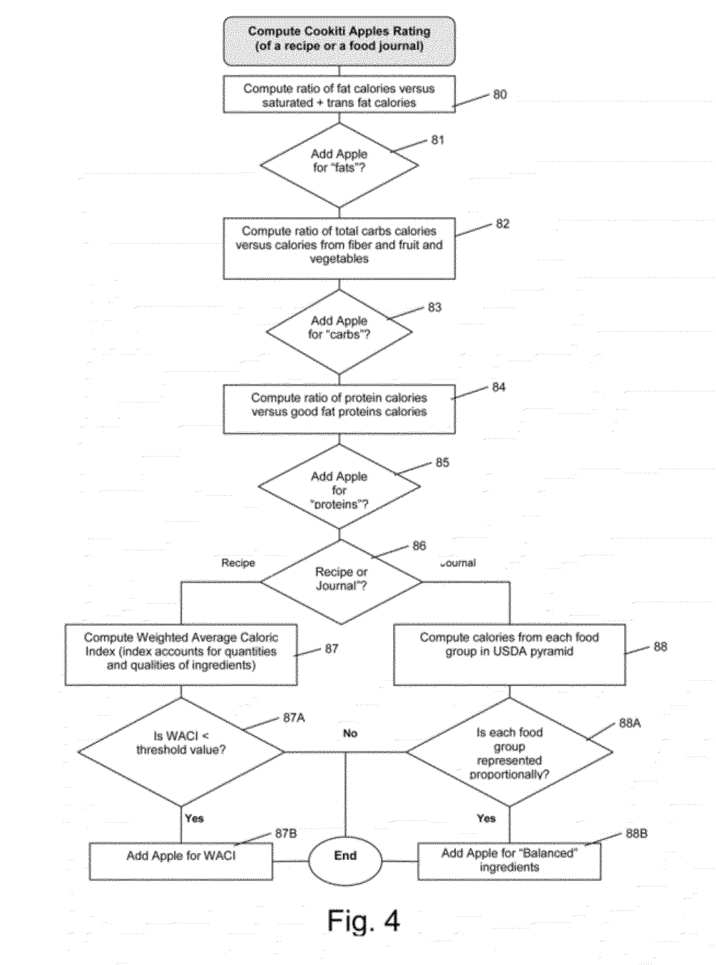

The process in FIG. 2 may invoke the Cookiti Apples Rating compute method shown in FIG. 4 to compute the number of “apples” for the current list of ingredients.

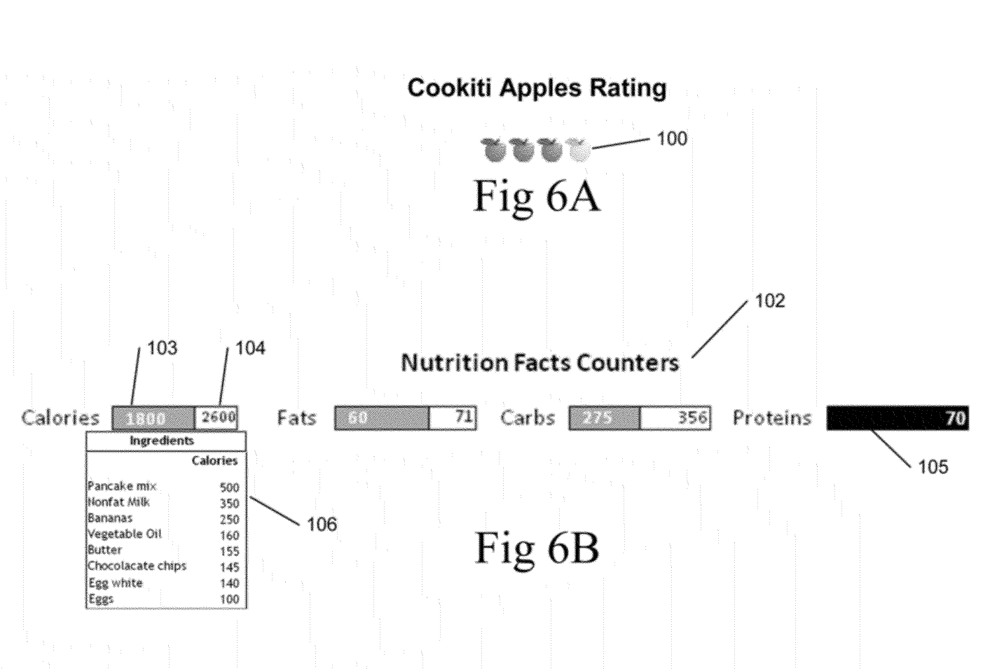

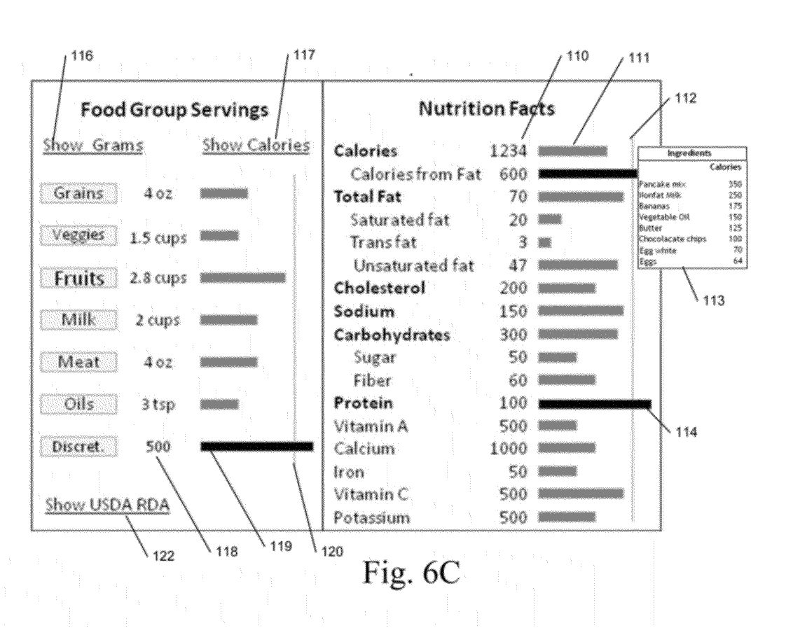

The Cookiti Apples Rating in FIG. 6A associated with recipes and food journals is a visual representation of the quality of a recipe and of food journal in terms of caloric and nutritional content and a balanced representation of food groups. It gives immediate visual feedback on nutritional and health quality of selected ingredients as a whole in terms of calories, fats, carbohydrates, and proteins. The module relies on the following methods to determine the rating:

Method 80 computes the amount of calories from fat and the amount of calories from saturated and trans fats. If the ratio of fat calories in relation to total calories is less than a configurable value and if the ratio of saturated and trans fats is less than a configurable value the method 81 assign a “fat apple” to the current recipe or journal.

Method 82 similarly computes the total calories from fiber. If the ratio of calories from fiber in relation to total calories is greater than a configurable amount the method 83 assign a “carbohydrate apple” to the current recipe or journal.

Method 84 computes the ratio of calories from proteins and the total calories from unsaturated fats. If the ratio of proteins is within a configurable range and the ratio of calories from unsaturated fats in relation to total fat calories is higher than a configurable value then the method 85 assigns a “protein apple” to the recipe or journal.

The Cookiti Apples Rating computed this far is then adjusted negatively based on total cholesterol, cooking method of recipe, and if any ingredient exceeds the recommended servings by a configurable amount.

Last “apple rating” is computed differently depending 86 if the list of ingredients is for a recipe or a food journal. The method 88 and method 88A determine if food journals have a balanced representation of each food group relative to the USDA recommendations, while method 87 and method 87A determine if a recipe has a caloric index below a certain configurable value.

Method 87 computes the WACI (Weighted Average Caloric Index) of a recipe. Similarly to the caloric index of an ingredient or food, expressed as the number of calories in one gram of food, the WACI caloric index represents the ratio between the total calories in the recipe and the quantity of ingredients expressed in gram units. In the context of a recipe the caloric index is calculated for each food group represented in the recipe. The WACI index takes into account the caloric index of each food group in a recipe by totaling the caloric index of each food group weighted against the average serving size for that food group and the number of portions (servings) of the recipe. This is formula for computing a recipe WACI value:
1. For each f (Food Group) initialize three arrays for Calories (FCal), Measures (FMeas), and Default Servings (FServ)
   A) And for each i (Ingredient) in recipe do the following:
      I. FCal (i_{f})←Ingredient's Calories
      II. FMeas (i_{f})←Ingredient's Measure
      III. FServ (i_{f})←Ingredient's Default Serving Size
      IV. Compute food groups totals and averages:
         i) SUM_FCal (f)←SUM (FCal(i_{f}))
         ii) SUM_FMeas (f)←SUM (FMeas(i_{f}))
         iii) AVG_FSery (f)←AVERAGE (FServ(i_{f}))
      V. Compute each food group multiplier as
         i) X-plier (f)←F SUM_FMeas(f)/(AVG_FServ(f)*Recipe's Servings)
         ii) If X-Plier (f)>1 THEN X-Plier(f)←X-Plier(f)̂2
      VI. Compute each food group caloric index as
         i) FCI(f)←(SUM_FCal (f)/SUM_FMeas (f)*X-Plier(f)
2. Compute and Store the Weighted Average Caloric Index
   WACI←SUM(FCI (f)*SUM_FCal (f)/SUM (SUM_FCal (f))

The multiplier in step V.i and V.ii basically determines if a recipe should be penalized if the amount of ingredients within a food group is excessive.

Nutrition Display Module

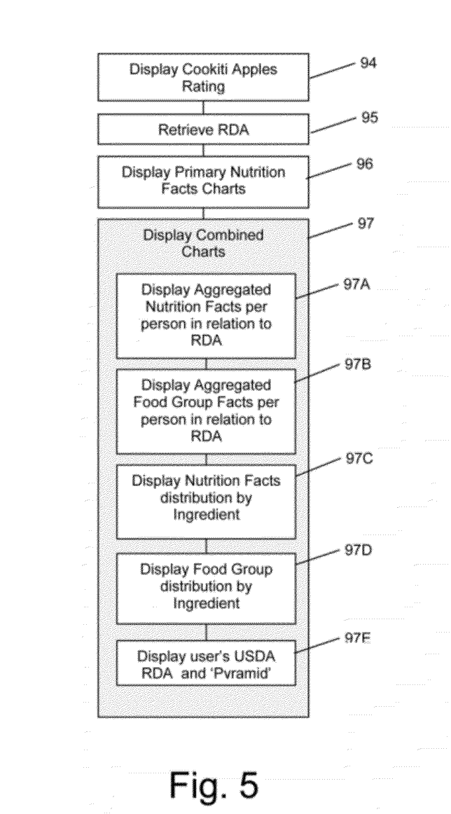

After the Cookiti Apples Rating is computed, the process shown in FIG. 2 invokes the Nutrition Display Module shown in FIG. 5 to display the computed Cookiti Apples Rating, primary nutritional facts charts, nutrients and food group servings relatively to the USDA RDA values for the current user profile.

Method 94 displays the Cookiti Apples Rating in a format similar to FIG. 6A. The Rating is updated as user adds, changes or removes ingredients from the ingredients list.

Method 95 retrieves the user RDA values from 49G.

Method 96 displays the Primary Nutrition Facts as from profile in a format similar to FIG. 6B, comparing each nutrient to the respective RDA value.

The method 97 displays the combined nutrients chart and food group chart in a format similar to FIG. 6C. The innovative approach of this representation is that both nutrient values and food group servings, for the current list of ingredients, are represented together on the same screen. Furthermore, each nutrient and food group aggregated values are displayed in relation to the RDA values 97A and 97B. Furthermore, upon user request, methods 97C and 97D display for each nutrient or food group values by ingredient 113, therefore allowing user to determine which ingredient in the ingredient list contributes the most to a given nutrient or food group. Finally, upon user request, method 97E displays the actual RDA values for both nutrients and food groups.

In FIG. 6B the value 103 represents the aggregated value of the nutrient for the current list of ingredients, while 104 represents the recommended daily allowance of the nutrient respectively to current personal profile. Method 106 shows the nutrient distribution by each ingredient in the list. The representation of the nutrient 105 shows a nutrient exceeding the recommended daily allowance.

FIG. 6C shows the visual representation of method 97 with the combined view of nutrients and food groups. Similar to the bar charts used for the primary nutrition facts, the bar charts 111 and 119 compare the current totals versus the recommended daily allowance for each nutrient 112 and for each food group 120, respectively. To be noted in FIG. 6C also the method's implementation of multiple views of the food group servings; default is by servings as defined in USDA recommendations, or user can view food group data by metric grams 116 or by calories 117. Method 118 is the visual representation of method 76. Lastly, method 122 shows the USDA recommended daily allowances for the current user profile.

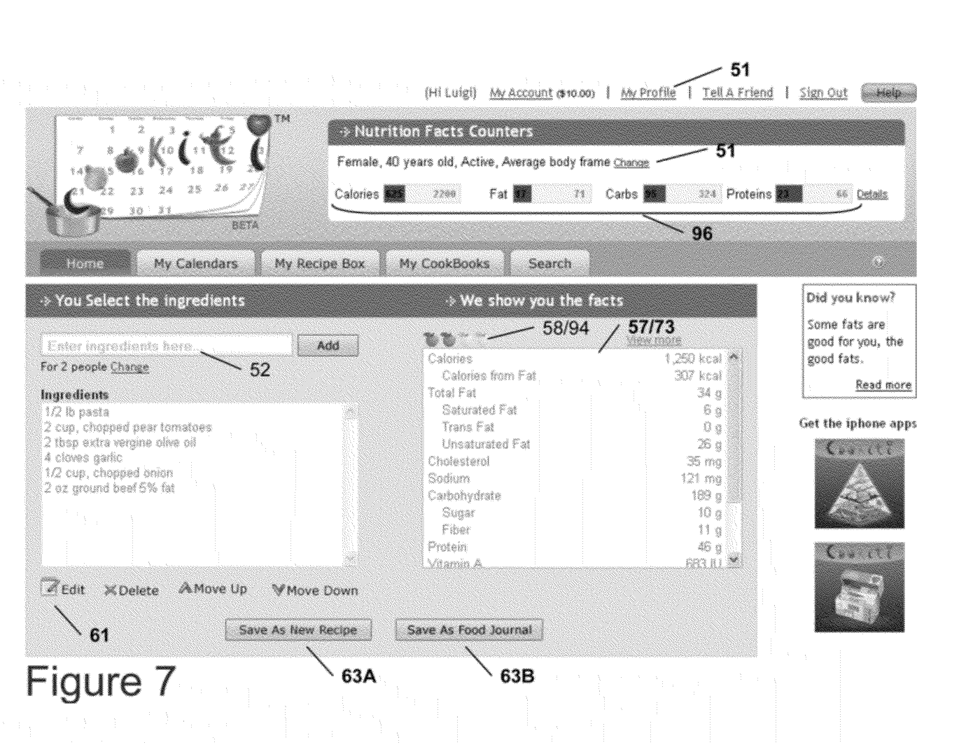

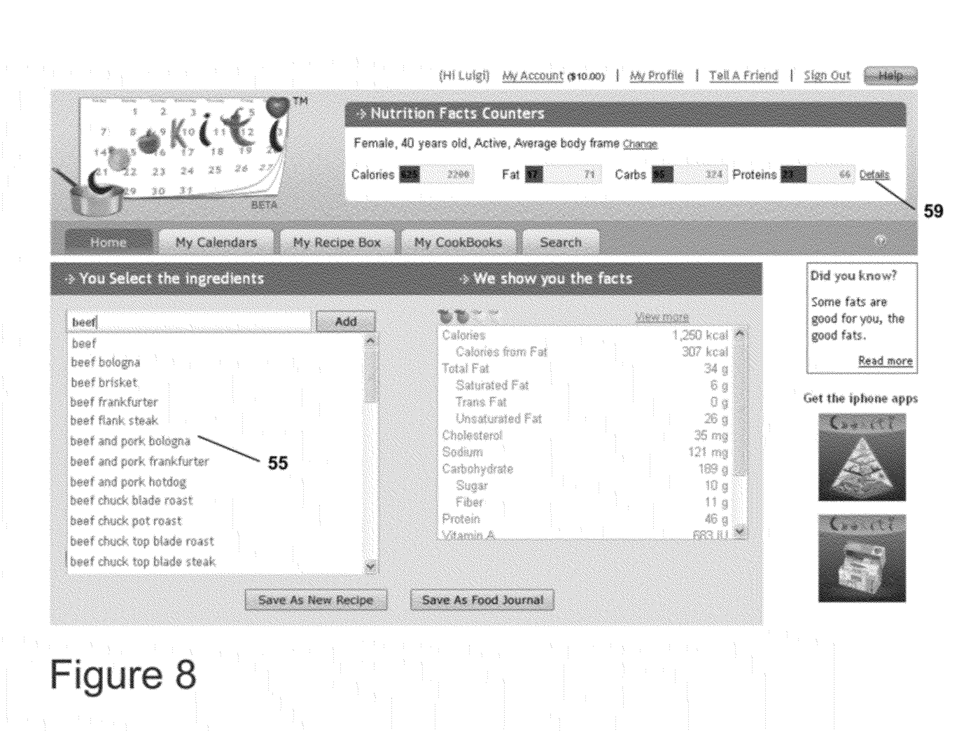

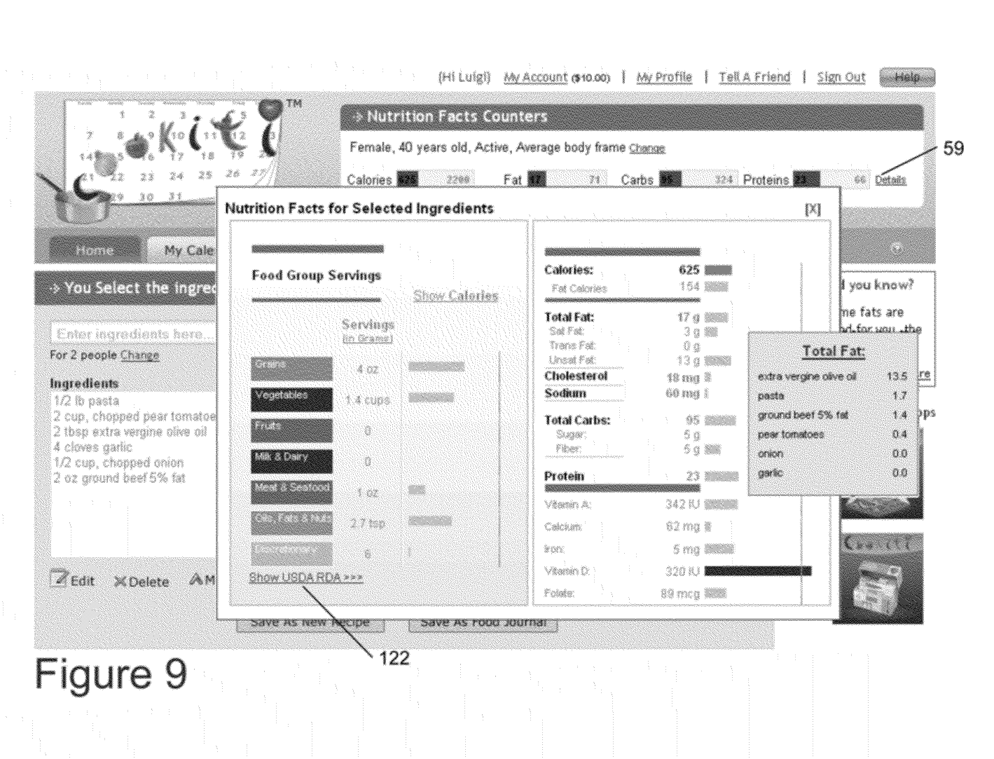

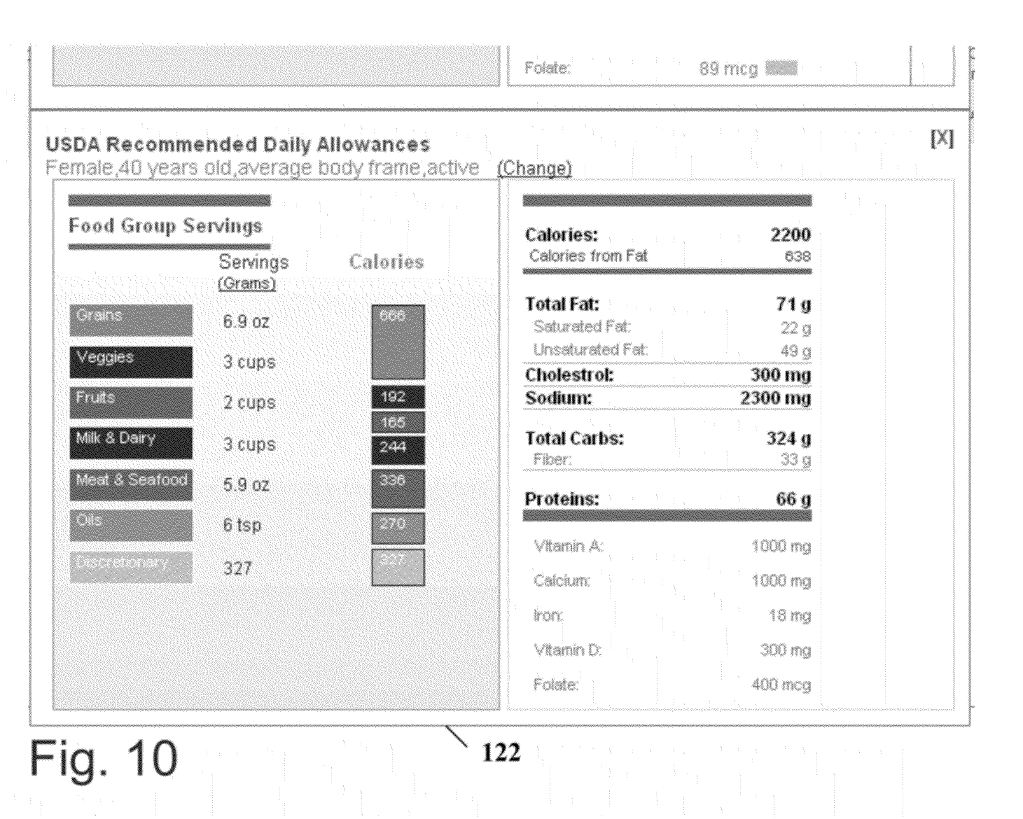

A prototype visual implementation of the Nutrition Facts Counters Module 43 is shown in FIGS. 7-10.

Recipe Box Manager Module

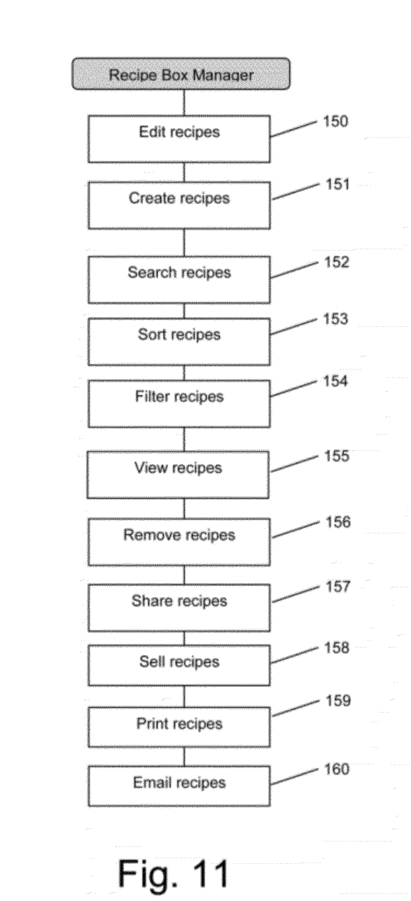

The module Recipe Box manager module 44 and FIG. 11 include methods that give users ability to easily find own or favorite recipes, edit existing or create new recipes through a recipe editor, search, sort, view, and share recipes.

The recipe box module views separate food journals, user own recipes, and other chef recipes. Other chef recipes are added to recipe box as favorite thru the search module 50.

The view methods display the primary nutrition facts, Cookiti Apples ratings, preparation time, cooking time and other properties of recipes that give users sufficient details of a recipe to minimize page context changes. In particular, methods 155A and 155B give users ability to peek ‘in place’ for additional details, or play video 155C attached to a recipe ‘in place’.

The recipe editor includes methods that allow users to select values from predefined lists, e.g. Course, Cuisine, enter or paste ingredients and measures as discussed in 43, enter or paste instructions and remarks, upload or select video, upload one ore multiple photos.

The edit methods 150 and 151 allow user to edit or create recipes. The recipe editor requires basic computer skills such as typing, pasting, selecting, browsing from local computer for photos or videos to upload.

The search method 152, 158, 159 allows users to search recipes in recipes box by ingredients in recipes or journals or by keywords in recipe name. The method 159 provides configurable predefined recipe box search criteria, e.g. “low fat”, “low cholesterol” recipes.

The sort recipes method 153 allows users to sort recipe box according to predefined criteria that allow users to search by nutrients, Cookiti Apples Ratings, or other ‘common interest’ criteria such as by low fats, by low carbohydrates, etc.

The filter methods 154 allows users to include in the recipe box view recipes that meet certain predefined criteria, such as by courses, by chef, by status, i.e. private or public, etc.

The remove method 156 allows users to clean recipe box of recipes that are no longer of interest.

One of the innovative features introduced by the Recipe Box module is the ability for users to share 157 and sell recipes 158. Users share recipes with friends, share recipes with public for free, for a price or accept donations. In this manner, the method allows users to add or buy recipes from other chefs, these recipes known to the buyer chef as ‘favorite recipes’.

Print 159/162 and email 160/163 recipes allow users to ‘save’ recipes on paper or ‘share’ recipes with non-members of the service. Non-members receive a properly formatted recipe in PDF format.

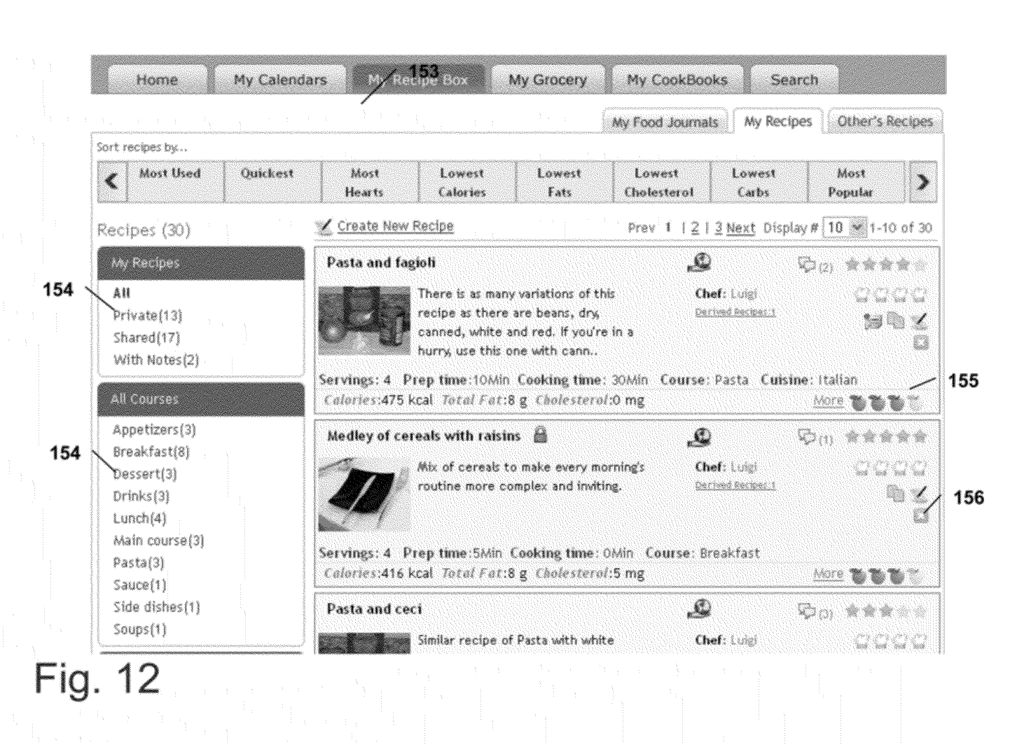

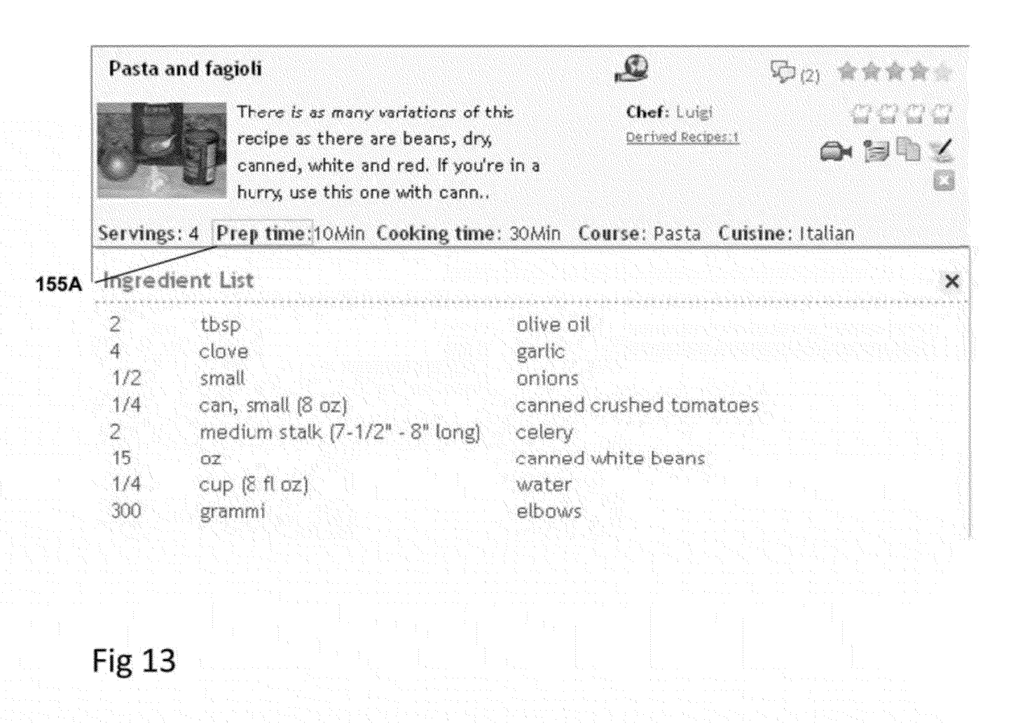

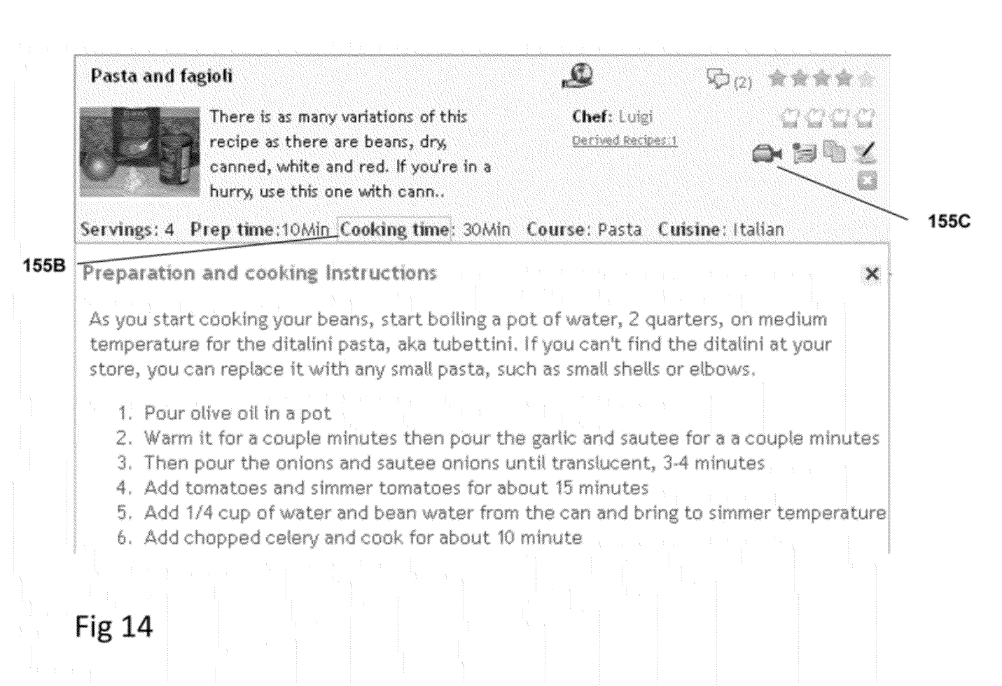

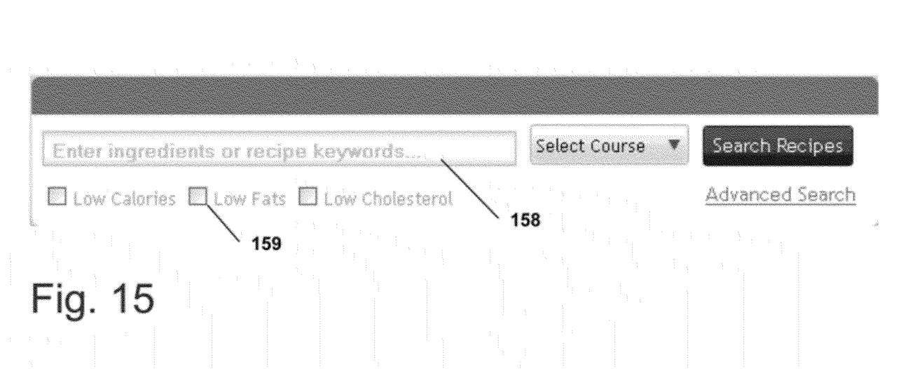

A prototype visual implementation of the Recipe Box Manager module is shown in FIGS. 11-15.

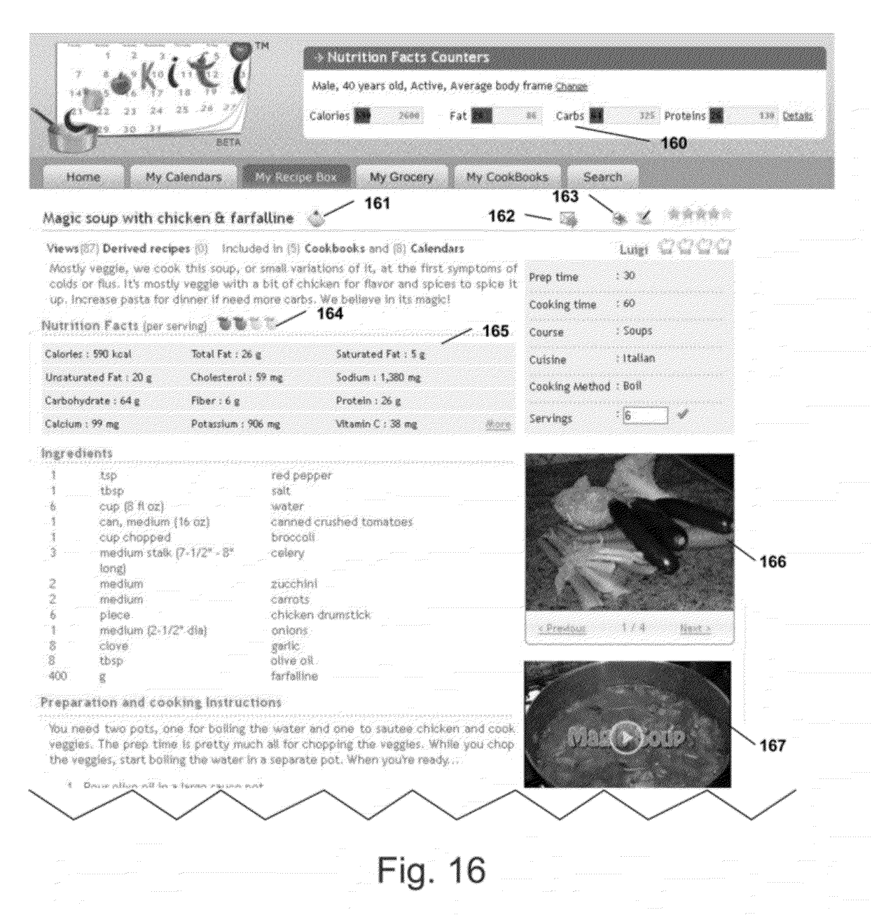

A prototype implementation of a recipe viewer 155 is shown in FIG. 16; it shows the full content of recipe emphasizing recipe's nutrition facts 160, 165, the Cookiti Apples Ratings 164, and ability to add personal sticky notes 161. The method 166 167 show the recipe photo slide show and video that can be played in-place.

Cookbooks Manager (Co-Authored Interactive Books of Recipes)

The cookbooks manager 46 and detailed in FIG. 17 allows users with basic computer and web navigation skills to create collections of recipes in recipe box 49E as electronic online books and eBooks 49F.

The create cookbook method 180 allows users to create a new book framework that will hold the actual content. The create cookbook method is detailed in FIG. 17B. The method allows user to specify a Title 180A, a brief introduction 180B, and cover page picture 180C. The chef's name and 180A, 180B, and 180C will appear on the book's cover page in the layout defined by the selected cover page template 180E. The method provides user a rich text area field to store the book introduction which would appear before the table contents and after the cookbook cover page. The method also allows user to choose which tables of content to include with cookbook 180G and a recipe page template 180F which will determine the layout of recipe pages in eBook.

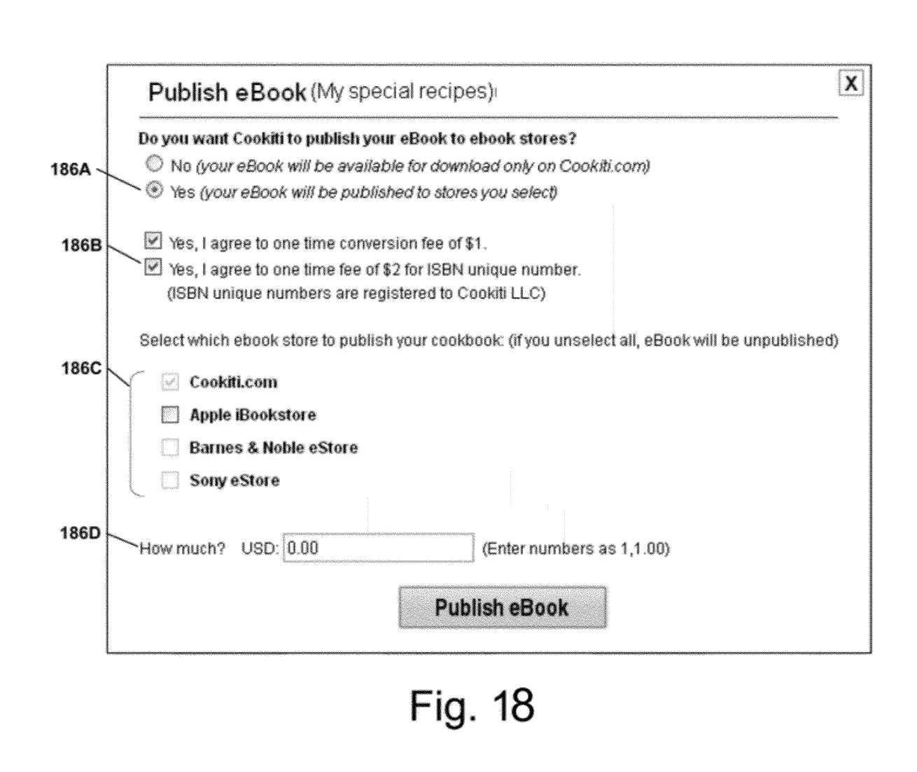

The share method 181 in FIG. 17 allows users to share access to the cookbook with selected friends and public. The share method is detailed in FIG. 17C. The method allows owner of cookbook to release it to the public 181A which would normally be done once cookbook is done, and more importantly the method allows user to grant ‘modify’ access 181C to friends and other family members registered with system 181B; members added in 181B become effectively co-authors, thus allowing them to add their own recipes and favorite recipes to the cookbook. The share method also allows owner to define cost once the cookbook is shared with the public. It allows user to share if for free, accept donations, or set an access fee 181D. Lastly, the share method allows user to create an eBook version of the cookbook 181E which is detailed further in FIG. 18.

The recipe organizer method 182 gives users the ability to add recipes from own recipe box, sort and remove recipes. The recipe organizer method is detailed in FIG. 17D. According to an embodiment of the present invention, the recipe organizer method determines how users “add” recipes to cookbook. The method allows users to perform this task with a single drag action 182F of a recipe from recipe pane 182A to the cookbook's recipe organizer 182B both accessible within the same screen.

The preview method 182D gives user instant feedback on cookbook layout and pagination, while the method 182E gives user the ability to filter recipes by chapter and therefore ability to check which recipes will be part of each individual TOC chapter.

The compute method 183, further detailed in FIG. 17E, automatically updates the active tables of content as recipes are added, moved, or removed from cookbook organizer Each line item in a table of content effectively represents a virtual chapter of the book that user can jump to and browse. The computed chapters have overlapping content filtered by the table of content type and sorted according to the sequence of recipes specified in organizer 182.

Update Tables of Content

FIG. 17E shows the internal representation of cookbooks. The cookbook properties, such as title, templates, introduction, etc. are stored in the cookbook data store 183A. The cookbook data store includes all recipe IDs that belong to the cookbook and sourced from different users 183B. The chapters data store 183C includes the list of table of contents (TOC) selected for the cookbook. The content of each TOC is determined thru a select query in cookbook 183A with a filtering criteria in recipes table; the output of the query is the list of recipes in cookbook that belong to a chapter.

The output of select queries are cached in the TOC data stores 183D; they represent the chapters to be used to navigate the cookbook, as detailed in FIG. 17F. Method 184 in FIG. 17B allows user to sort recipes in cookbook organizer which will invoke the method 183 to update the tables of content. Similarly, if user chooses to add another recipe to cookbook organizer, it will cause the table of contents to be updated 183.

The Cookbook Navigation

Turning now to FIG. 17F, the cookbook navigation 185 allows for viewing and navigating the online cookbook (and corresponding eBook). The navigation method 185A allows user to flip through the sequence of pages and recipes in cookbook 185B or navigate directly to an individual chapter and flip through the recipes 185C in the selected chapter. The method 185D allows user to navigate back to the cover page of the cookbook. The method 185E allows user to flip to next recipe or flip back to previous recipe in book or chapter. The method 185F displays each recipe's default nutrition facts per serving in cookbook as well as allows user to drill-down to view nutrition details within the page. The method 185G allows user to change profile to have recipe's nutrition facts compared and charted against RDA. The method 185H allows user to view each recipe's photos in place within the page. The method 185I allows user to view a recipe's video in place within the page. The method 185I allows user to change the recipe servings to re-compute quantity and measures of recipe ingredients based on new servings.

The interactivity capabilities in 185F through 185J are detailed further in the ePub conversion section below.

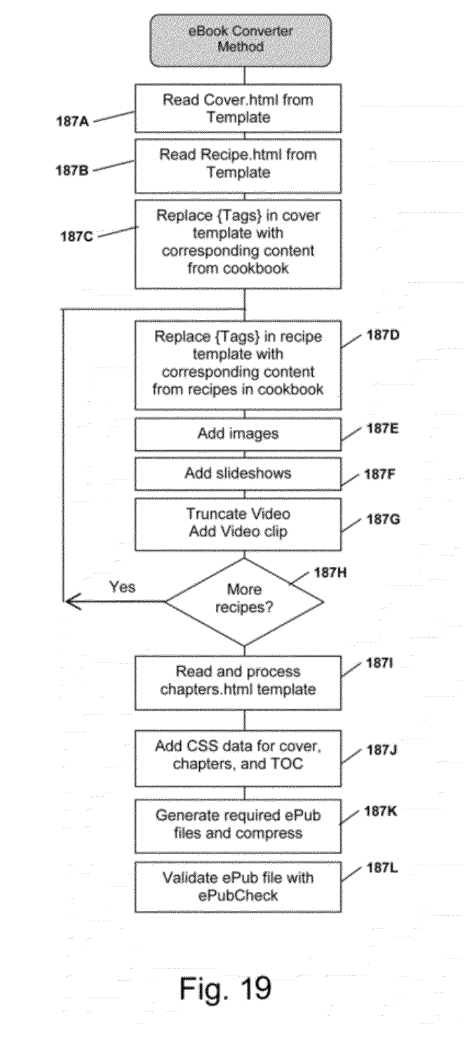

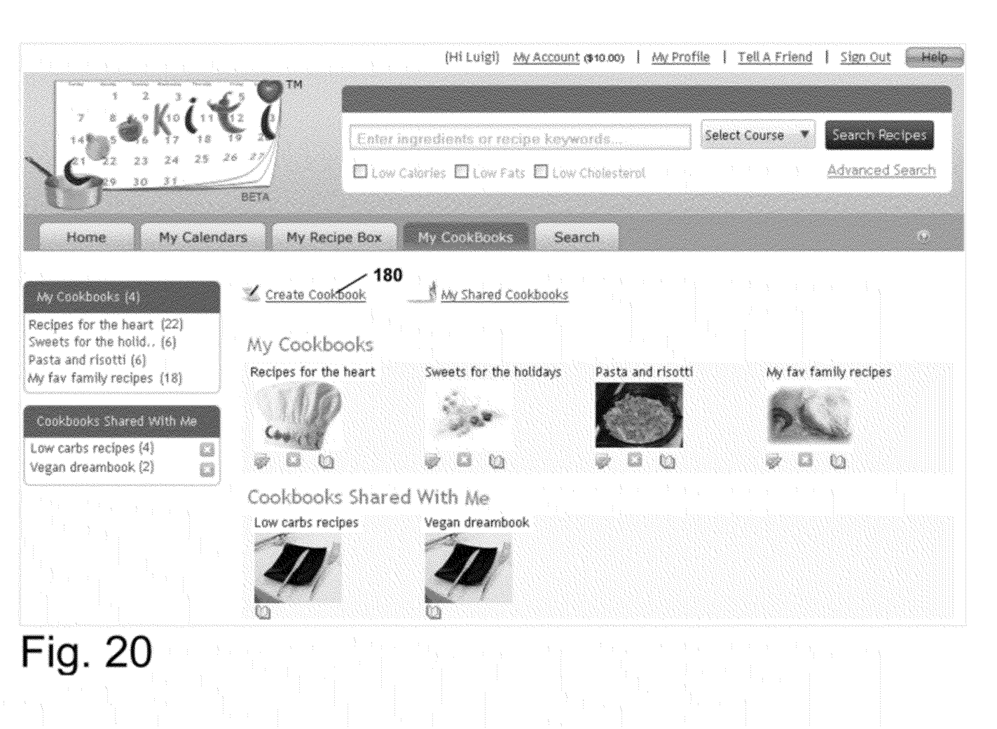

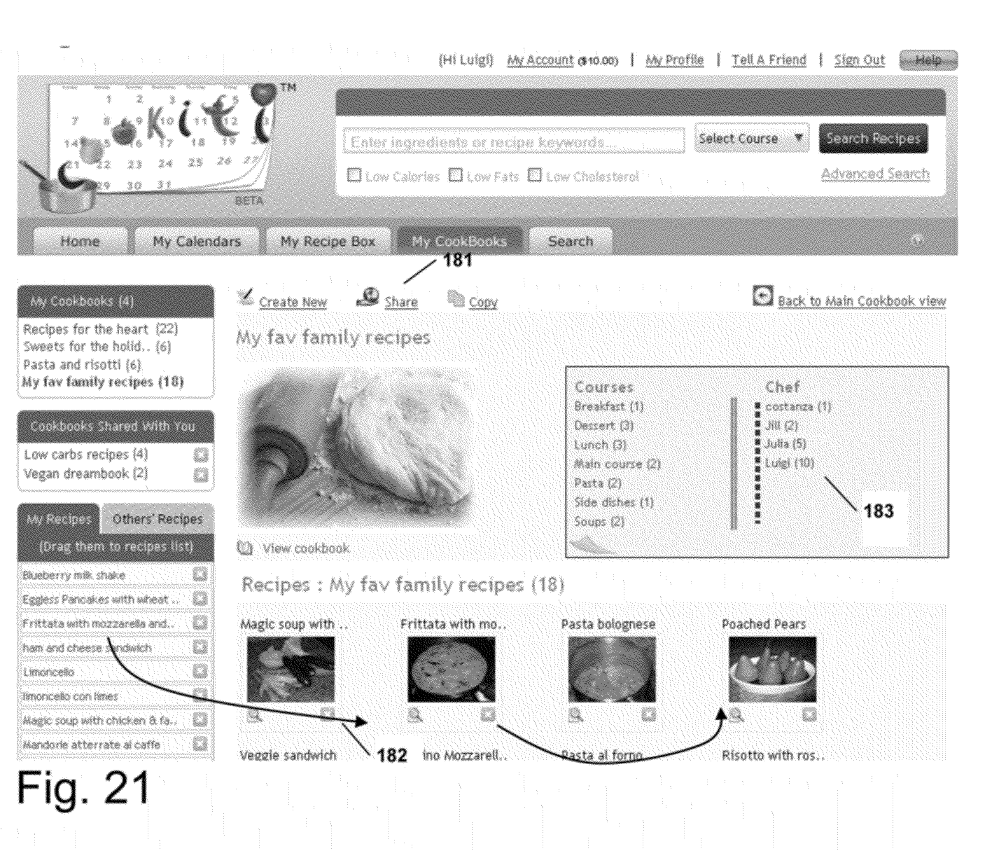

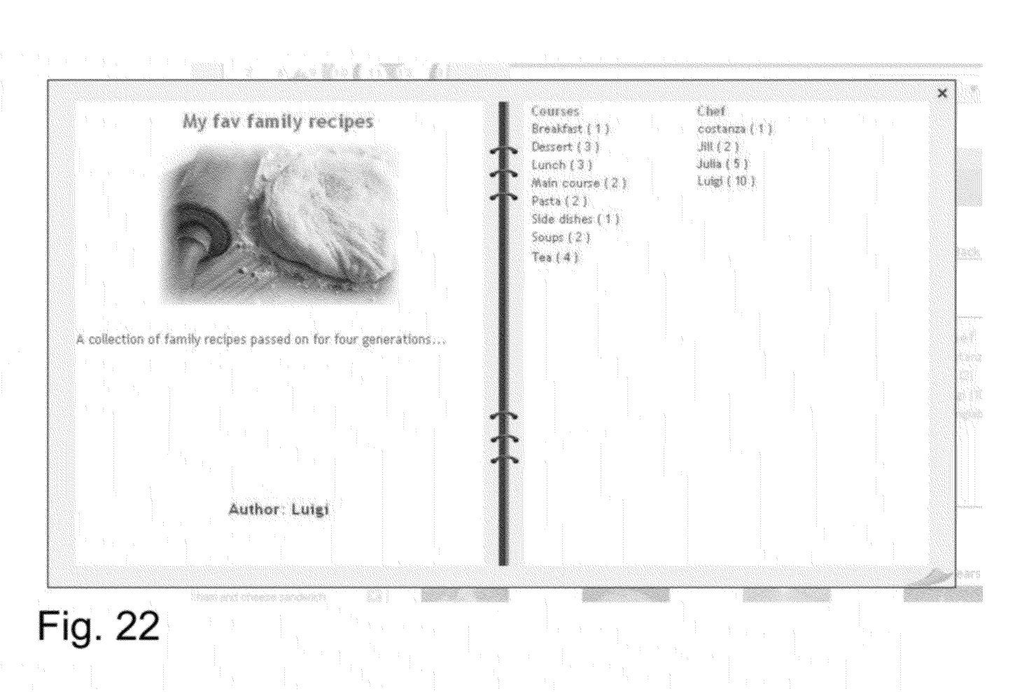

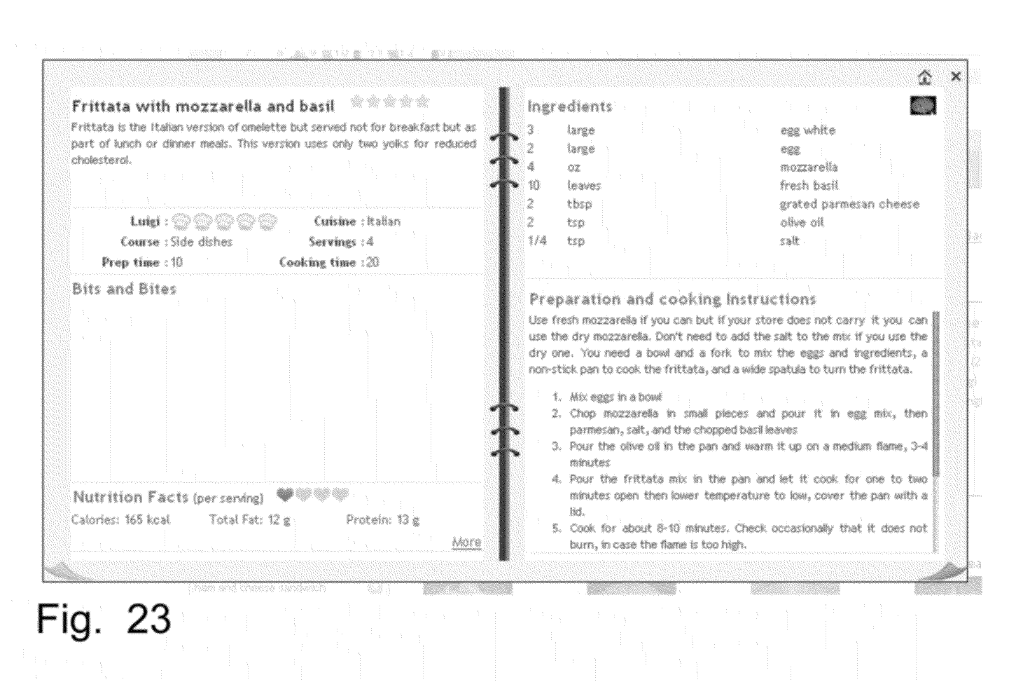

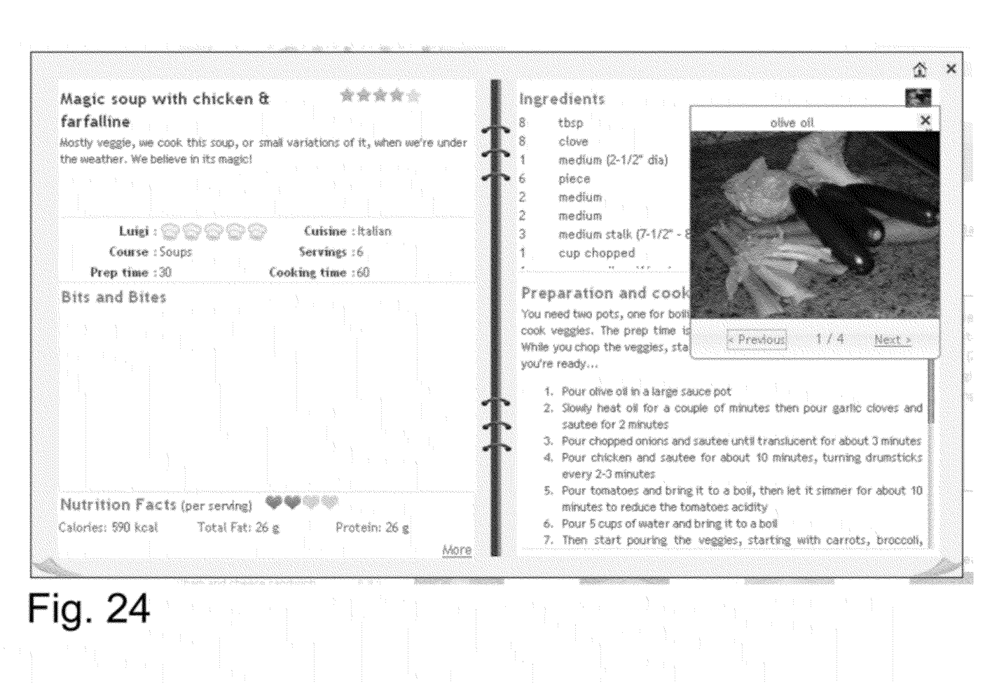

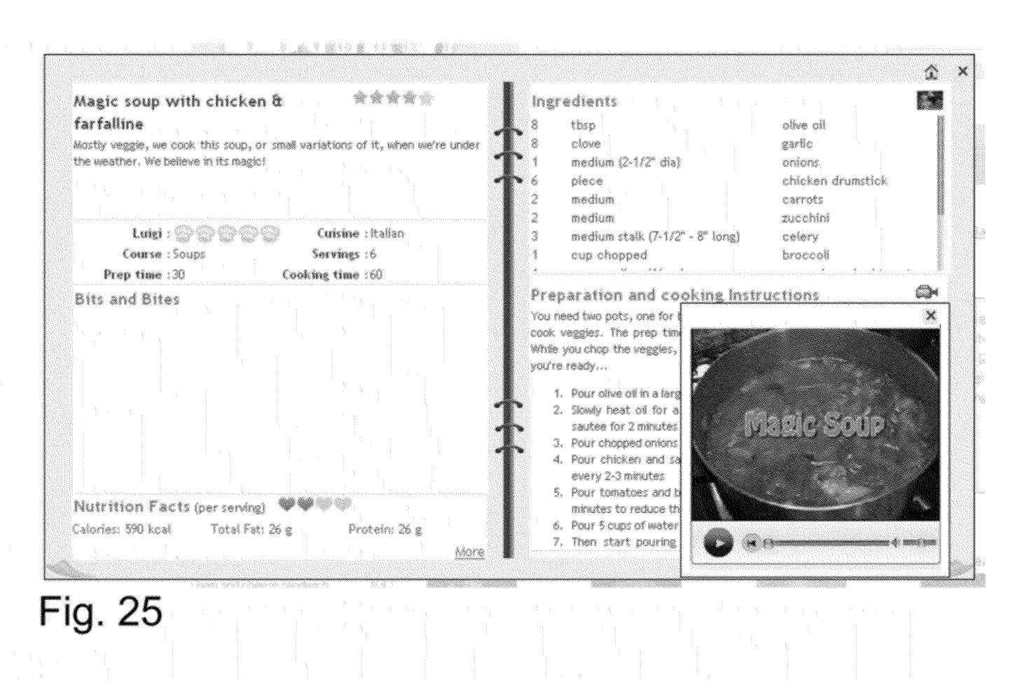

The publish method 186 is detailed in FIG. 18 which uses the ePub Converter method 187 and detailed in FIG. 19. The ePub converter method creates a standard ePub formatted file that can be transmitted to eBook stores or downloaded to tablet devices or any reader device capable of reading such standard files. The eBook publishing gateway 188 handles the actual transfer of the ePub file to the eBook stores. The publishing gateway is prior art and provided as service from external provider.

The Publish Method 186

Turning now to FIG. 18, Option 186A gives user the option to publish eBook to web sites and to eBook stores. In order to publish to eBook stores the publish method assigns an ISBN number 186B to the eBook. ISBN numbers are pre-loaded in data store 49F. The next step in publish method is to store the user preference 186C of which eBook stores to publish eBook. Lastly, compute the eBook listing price. The optional add-on fee 186D to the cookbook price would be to cover publishing fees imposed by eBook stores or other intermediary fees.

The eBook Converter Method 187

Turning now to FIG. 19, This method for converting the created online cookbook to the ePub format can be applied to generate other standard eBook formats. The purpose of this step is to create an ePub archive file that is composed by a set of required ePub files 187L, xhtml files, pdf files, css files, and supporting images.

The first step in this process is to read in all sections templates, including the user selected cover page template 187A and recipe pages template 187B. Each section of the cookbook has a corresponding template, cover, introduction, table of contents, and recipes, and each template containing placeholders, special tags delimited by curly brackets, to be replaced with the actual content of the cookbook.

The next step in the process is to generate the cover.html file from template 187C; the cover data will include owner, title, the brief intro, and cover image. The layout data of the cover, i.e. positioning of various data elements and supporting images and background, are part of and referenced within the template itself. According to an embodiment of the present invention, the algorithm that takes place in this step 187C is to replace the special delimited tags {authors}, {title}, {tagline} with the actual data from the cookbook.

The next step is to process the introduction.html template and generate the introduction page based on the content in cookbook.

The next step is to generate the recipes.html sections from the recipe template by iterating for each recipe in cookbook 187D. Each of the recipe template's special tags are replaced with the actual content of the recipes 187D, i.e. title, description, course, instructions, remarks.

According to an embodiment of the present invention, default recipe template images are then added to recipe.html 187E. Slideshow images 187F may then be added to recipe.html and referenced through an object tag with text/html mime-type. According to an embodiment of the present invention, because of restriction imposed by eBook readers in rendering images within object tag, each slideshow image is converted to PDF.

Next step is to include the video associated with recipe in recipe.html file 187G. Video is encoded in a format compatible with the web and mobile reader devices. However, even in the best compressed format videos can increase the final output size considerably which could make ePub file too slow to download or install. Therefore, in accordance with an embodiment of the present invention, the suggested implementation is to truncate the video file to a clip of a configurable duration; the video clip will be viewed in place 1002, while the full length video is available when viewing the clip at a configurable URL and allowing user to view it through the local browser.

According to an embodiment of the present invention, videos are included in html5 video tag. For xhtml to be valid for epubcheck 187L, html5 tag containing video is included as xml island within ops:switch (using xhtml namespace):

<ops:switch xmlns:ops=”http://www.ipdf.org/2007/ops”>

<ops:case required-namespace=”http://www.w3.org/1999/xhtml”>

<video width=”...” height=”...” controls=”true”
autoplay=”true”>

<source type=”video/mp4” src=”....”/>

</video>

</ops:case>
<ops:default>

<div style=”width: 0; height: 0”></div>

</ops:default>

</ops:switch>

After processing all recipes in cookbook 187H, next step is to read and process the chapter template and generate the TOC html files and chapter html files 187I. Finally, the CSS style sheets are added to the epub assembly 187J.

At step 187K, the system generates the actual ePub file consisting of an assembly of the various html, pdf, image and video files and of the ePub required meta-data, book.ncf, and book.opf files. The ncf file stores the chapters sequence and order of the eBook while the opf file includes the book id, creator, title, etc. The method for creating the required epub files and files compression is prior art.

In the Last step 187L in the ePub conversion process is the validation of the ePub compressed file. Validation is required for being able to publish ePub files through online e-stores and it's done through an internal epubcheck component invoked programmatically.

Interactivity within ePub Archive—the Interactive eBook

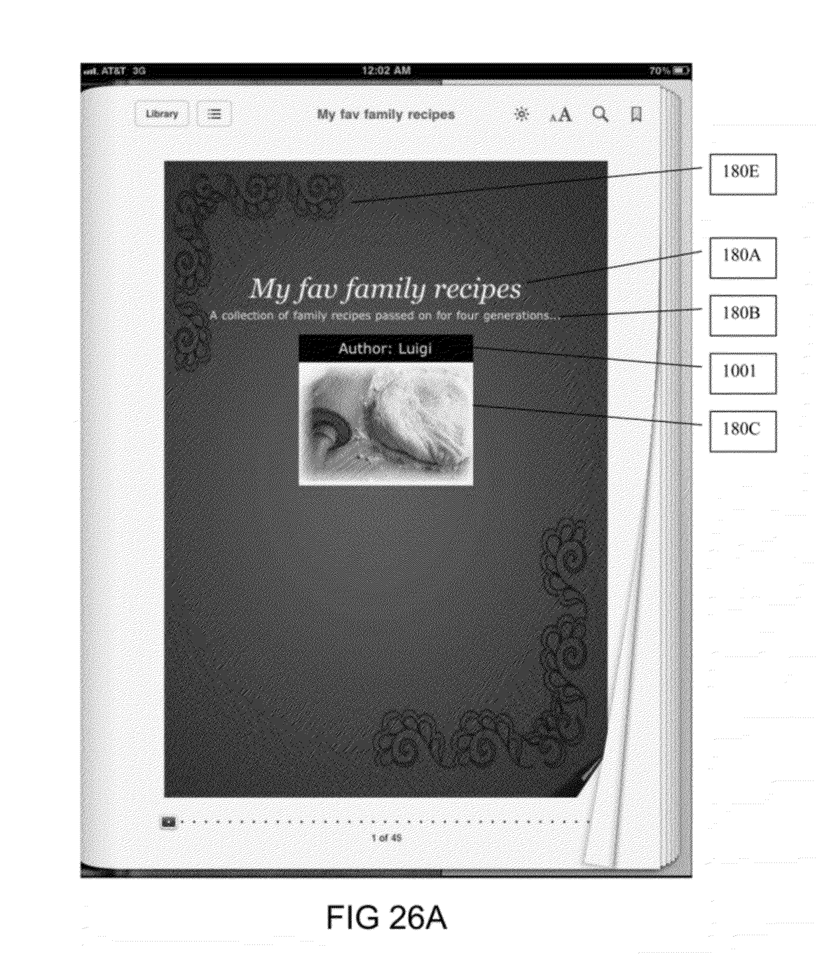

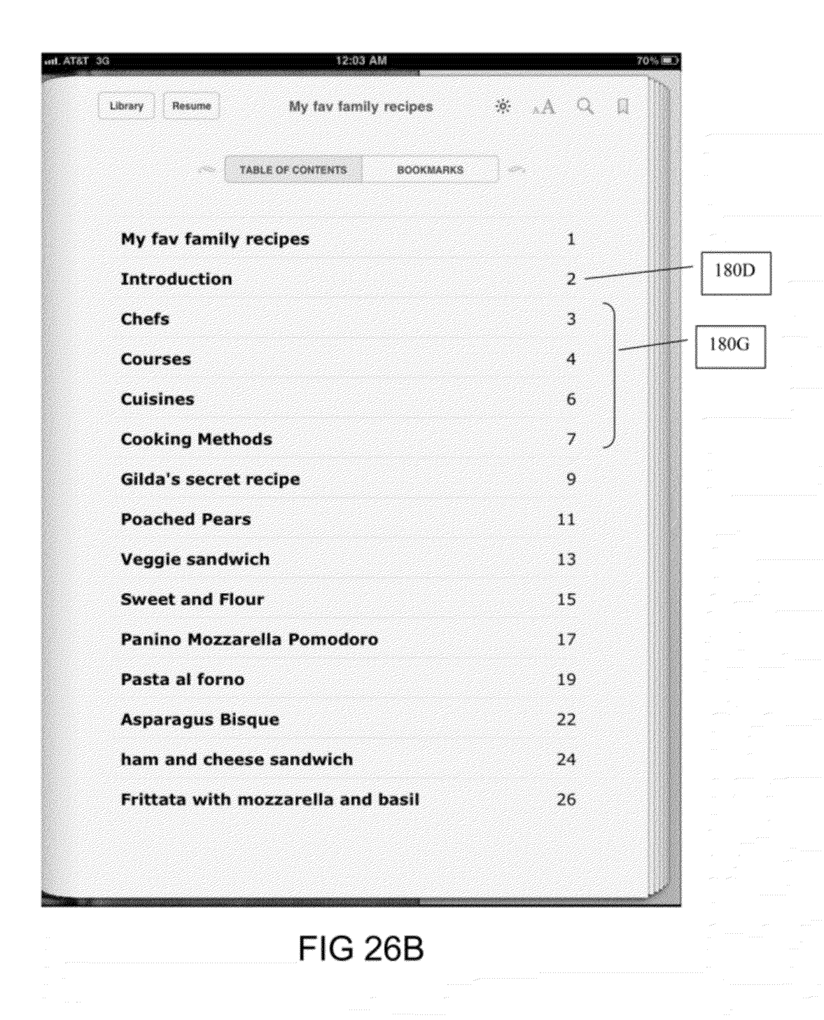

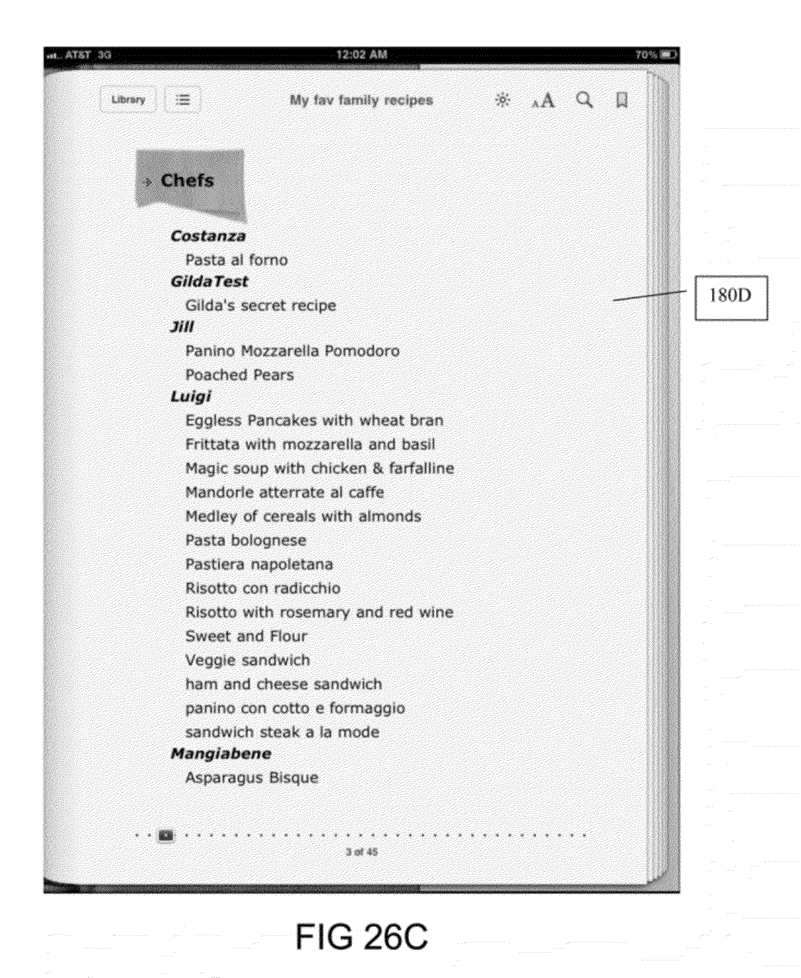

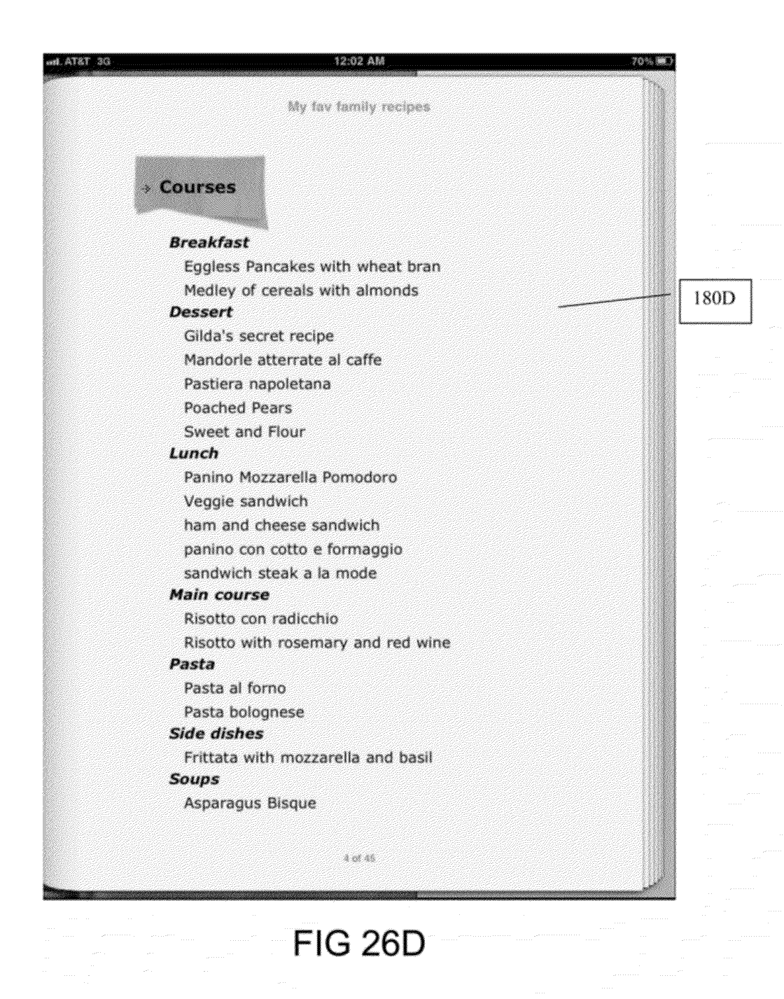

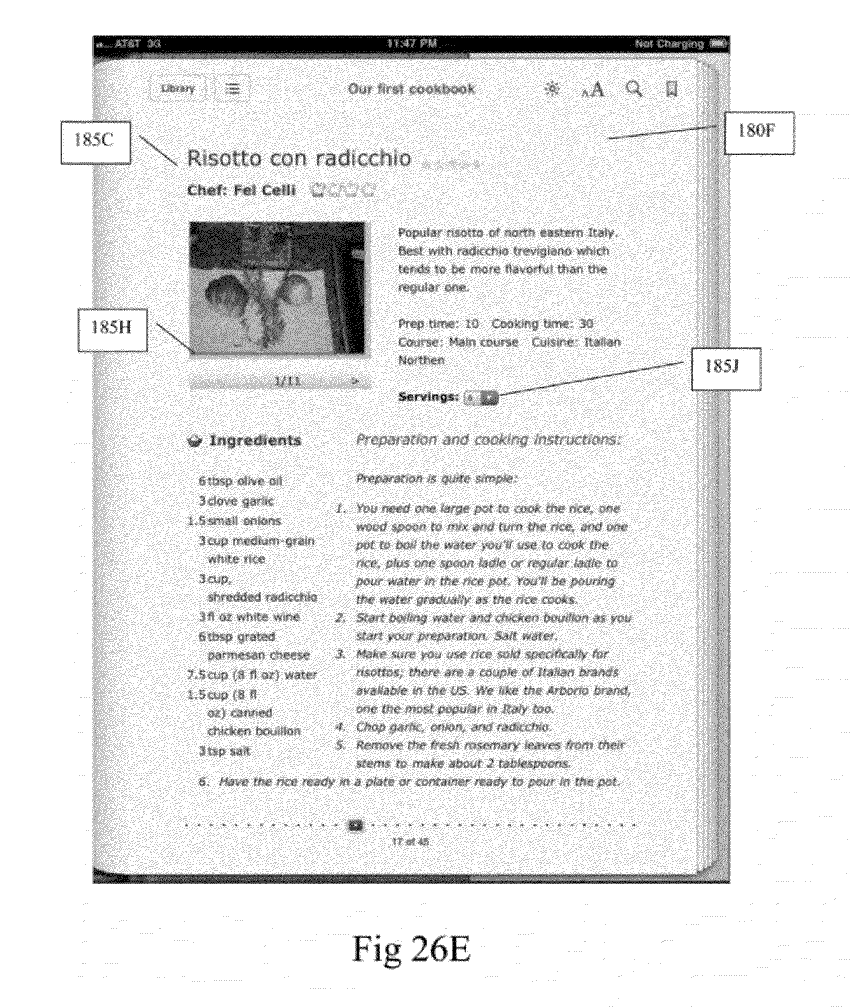

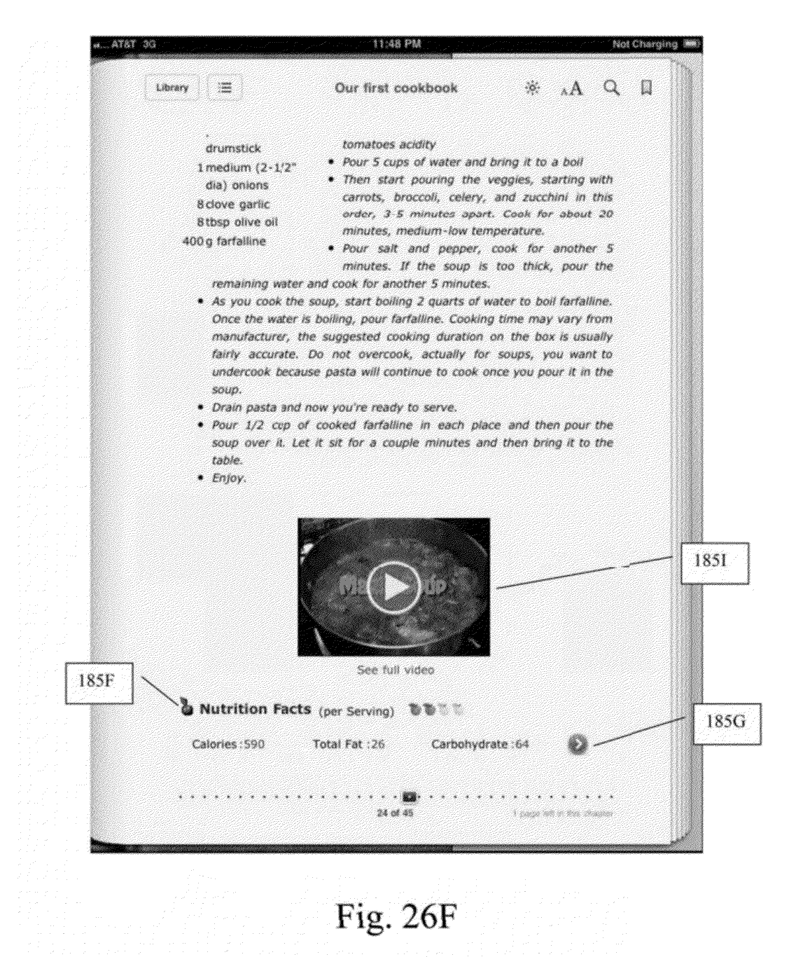

One of the elements of the ePub archive is an epub.js JavaScript file 49H with methods that implement interactivity in eBooks. Cookbooks use JavaScript by adding epub.js file (mime-type: “text/JavaScript”) to the ePub, and including a reference in each chapter.html before ending body tag. Because events can't be used within xhtml tags as it would invalidate epubcheck, to add events to DOM elements we use element ids and/or class names to identify them and then add event to them or change their innerHTML with event attached. This method doesn't break ePub validity because id and class for element is allowed, “text/JavaScript” mime-type, and script tag with “src” attribute also. The suggested implementation FIG. 26A-26F uses the above method to personalize the eBook viewing experience. Current methods in epub.js allow eBook users to change servings of recipes 185J to have measures and quantities of ingredients' recomputed FIG. 26E, and let users enter a personal profile 185G to have recipes' nutrition facts compared to USDA Recommended Daily Allowances FIG. 26F. Same technique can be used to add further interactivity and personalization of user experience.

Calendar Manager Module: Shared Meal Plans

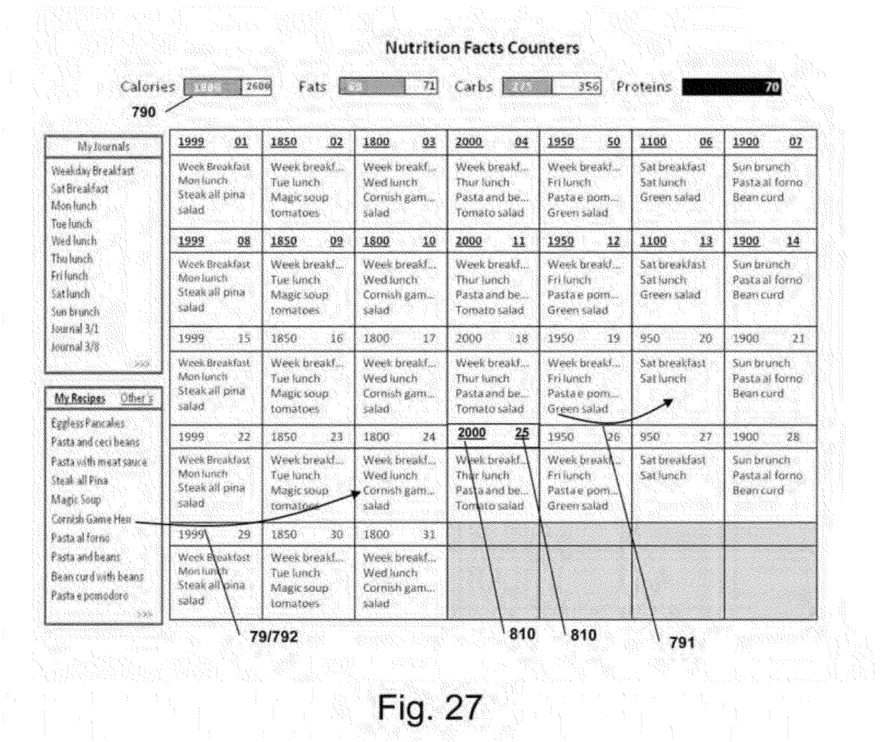

According to an embodiment of the present invention, a calendar manager module FIG. 28A allows users to create multiple monthly calendars, i.e. meal plans, using recipes and food journals in Recipe Box. A key method of the calendar module is how users “add” recipes and journals to calendar 79. The method allows users to perform this task with a single drag of a recipe or journal to the appropriate date in the calendar performed through a computer mouse click-and-release action or a tap-and-swipe action on a touch-based device. The invention use of a full monthly calendar FIG. 27 along with the list of recipes and journals accessible within the same screen or view makes this possible.

A planning method of the calendar manager module computes and displays the daily averages of primary nutrition facts, nutrients and food groups 790 and FIGS. 28B-28D.

The planning method shown in FIG. 28A details the responses to user actions for adding and moving recipes to monthly calendar 79/791/792, while FIGS. 28B-28D detail the behind the scenes computations.

Step 796 shown in FIG. 28B retrieves from user's profile the primary nutrition facts list and RDA values for current user's profile. The next step is to retrieve the current list of recipes and journals assigned to calendar 797A and corresponding ingredients' nutrients 797B. The method computes the daily averages of the primary nutrition facts 798A and visually charts the values relatively to the user's RDA values 798B. Upon user request, it then repeats same computation for daily averages of food group servings and all nutrients 799A and chart them relatively to user's RDA values 799B.

Another user request 100, shown in FIG. 28C, triggers the method to compute and display the daily averages for a given nutrient by Food Group, by recipes or journals, or by ingredients 104. The ability for users to view the averages with different criteria and drill-down from food groups or recipes to individual ingredients is what enables the user of the system to quickly learn and focus on the weaknesses or excesses of the meal plan with a single mouse or tap action 100/104, or at most 2 mouse or tap actions 100-108, or 104-110

In the food group view, the method computes, upon action from user selecting the value of a food group, the nutrient's values by ingredients. Likewise, the recipe view gives users the ability to see which recipes are affecting the daily average for a given nutrient the most; it computes, upon action from user selecting the value of a recipe, the nutrient's values by ingredients. Lastly, the ingredients view gives users the ability to see which ingredients overall, regardless of recipes, are affecting the daily averages the most.

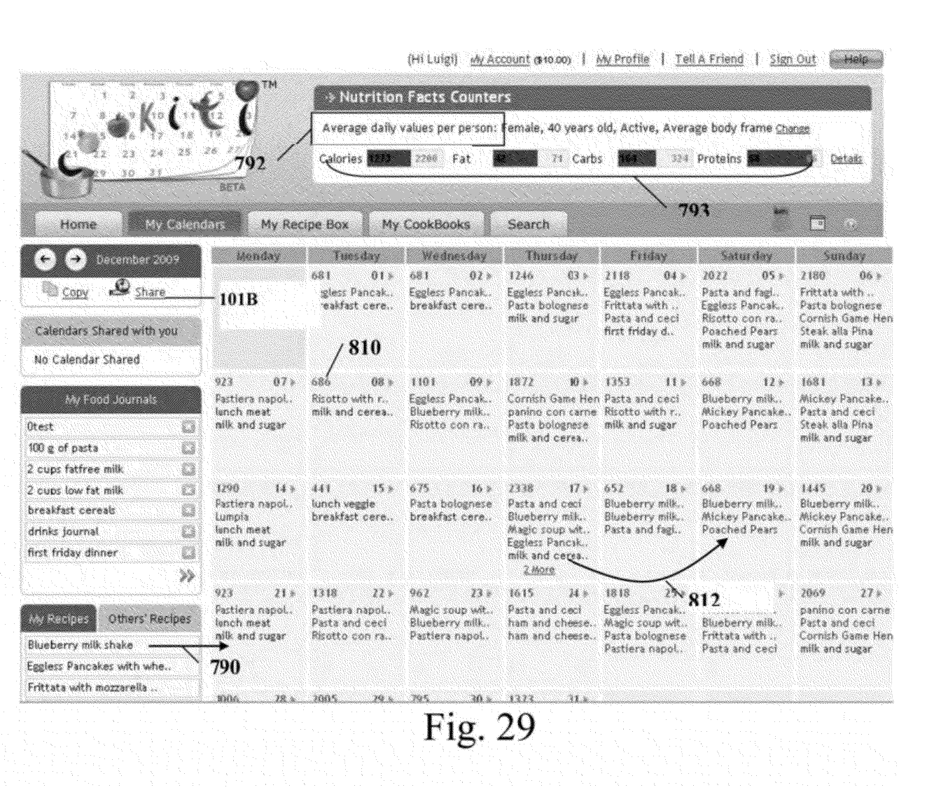

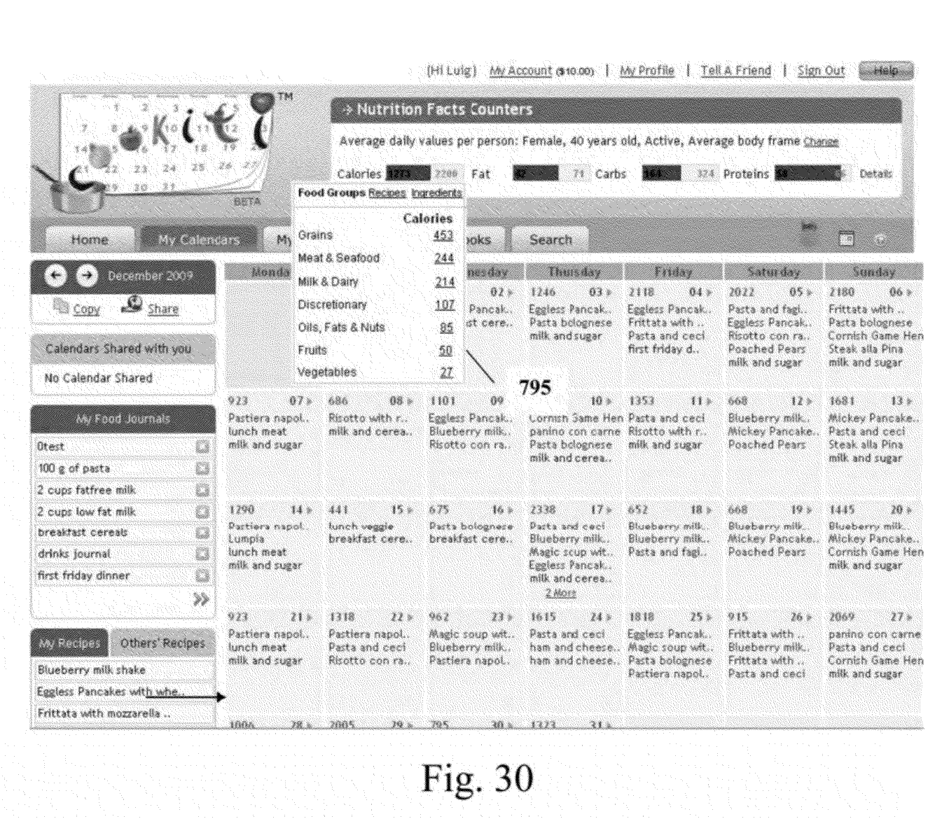

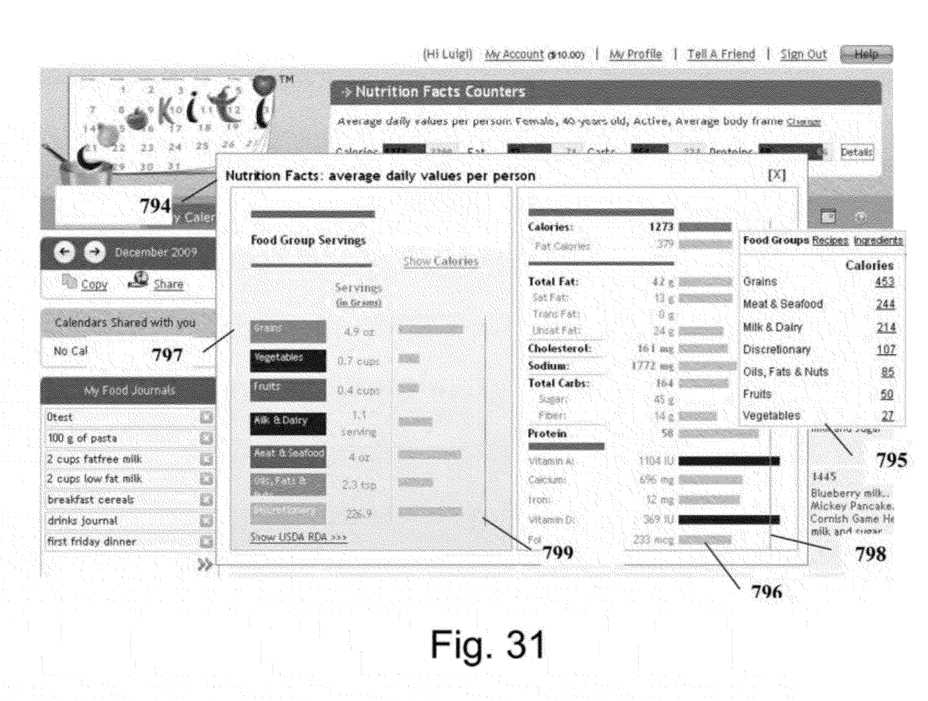

A possible implementation, in accordance with an exemplary embodiment of the present invention, of the calendar manager module is shown in FIG. 29.

According to an embodiment of the present invention, method 794 and 795 are detailed for computing and displaying in one screen the nutritional details of a meal plan in terms of macro nutrients, micro nutrients 796, and food groups 797 daily averages, visually charting and comparing each macro nutrient, micro nutrient 798, and food group 799 to the recommended daily allowances or food group recommendation. A method 810 is detailed for providing individual daily values of calories, as well as daily values of all macro nutrients, micro nutrients, and food groups and visually charting and comparing their values to each nutrient recommended daily value or food group recommendation. Finally, a method 812 is detailed for rearranging daily meal plans by moving recipes and food journals to another day by dragging said recipes or journals to a different day in the monthly plan.

Instructional Interactive eBooks

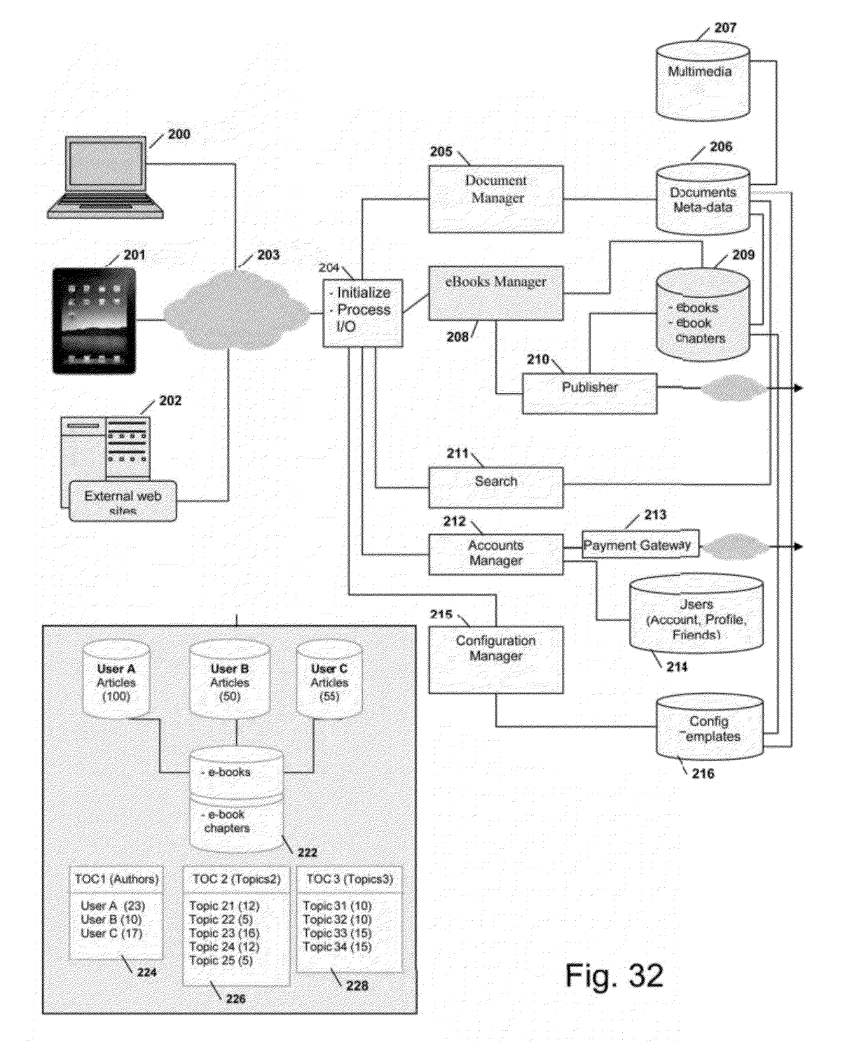

The process and methods of this invention can be reapplied to create a generic process as shown in FIG. 32, referenced above as Instructional Interactive eBooks, This new process allows users with basic computer skills create, collect, organize documents in electronic online books and eBooks. This new process allows users of the system to collaborate in the creation of the online books with each user contributing own or favorite documents; the process includes a conversion method where the online book is converted to the eBook format and a publishing method allowing users to distribute the newly eBook through online eBook stores. Interactivity in the eBooks comes from playing media incorporated in eBooks as well as being able to personalize the reader experience; for instance, instructional eBooks could allow user change the skill level to get different level of details on the instructions.

According to an embodiment of the present invention, a user of a remote device, computer 200 or a smart phone 201, or a partner web site 202, can access a service implementing the invention through the internet 203. An exemplary embodiment of the present invention is defined in the following paragraphs.

According to an embodiment of the present invention, a method 204 is provided that reads user's profile 214, if user is registered with service, authenticates user, initializes session, and processes all input and output from and to users at remote devices 200, 201, and 202. Users 200 would interact with 204 through a web browser, user on a mobile device 201 would interact with a local app and local app would interact with method 204 through web-based REST-like API services. Partner web sites 202 would interact with method 204 through web-based REST-like API services.

An initialization method 204 may also be utilized to determine user preferences, i.e. level of experience or skills, based on user profile in 214, and using the services of the accounts manager module 212.

According to an embodiment of the present invention, a document manager module 205 is provided that allows users to create documents using an html text editor, prior art, or import documents from other sources, using copy/paste, or by providing a URL and selecting a standard native format, XML, HTML or XHTML based, to use in the import process.

Methods in module 205 are presented to users for providing a title to the document, a brief introduction, and content, select predefined document properties or custom properties stored with document as meta-data in 206 and defined in config data store 216. A predefined property could be for instance the skill level required to read document or complete exercise. Additionally, user can upload images or photos and video associated with a document and stored in 207. Search and sort method 211 are provided to help users manage own documents and find and add other users' documents as favorite documents.

According to an embodiment of the present invention, the document manager 205 module separates the user's documents in own documents and favorite documents.

According to an embodiment of the present invention, the eBooks Manager module 208 allows users to create and manage books created with own or favorite documents. The eBooks Manager module 208 allows a user create a book framework and invite other members of the service implementing the invention to contribute to the book content each with own or favorite documents. The eBooks Manager module 208 may also support a book framework composed of several pre-defined html templates stored in 216; user creator selects the ones to use for cover and document pages. Each template provides the frame and layout while the documents themselves provide the content. The book creation method in eBooks Manager module 208 merges the documents with the templates, substituting the pre-defined unique tags in templates with the actual content.

A book organizer method in eBooks Manager module 208 allows users to add documents from user's own or favorite documents lists directly into the organizer by dragging said documents. Users can sort documents by dragging them to the exact location within the book organizer

According to an embodiment of the present invention, the chapters of the book are built from the number and sequence of documents in the book, and based on document's meta-data. Meta-data is composed of default properties, such as document creation date, author, document type, or language, and custom document properties, such as skills required to read document. Such properties are created and managed through the configuration manager 215.

Services implementing this invention will differ on the type and number of default and custom document properties, because said properties are specific to the particular audience of the eBooks. For instance, the properties of documents in cookbooks, i.e. recipes, are course, cuisine, preparation time (cooking skill level), cooking time, nutrients, etc; while the properties for an instructional book on how to install TVs will have TV size, manufacturer, technology, technical skills level, etc.

According to an embodiment of the present invention, a configuration manager gives users the option to create new properties and designate them as required or optional. Required properties are those that require user creating a new document to provide or select a value for said properties before document can be saved to documents data store 206.

According to an embodiment of the present invention, eBooks Manager module 208 gives user the ability to select which table of content to generate automatically based on the available document properties.

According to an embodiment of the present invention, the book publisher 210 is responsible for the conversion of the online book in the eBook format. This consists of assembling and merging of templates with documents to generate the actual ePub archive file of text, images, and videos.

According to an embodiment of the present invention, the book workflow process for creating, sharing and collaborating, and publishing methods described in FIGS. 17-19 apply to this Instructional Interactive eBooks process as well. The ePub conversion method described in FIG. 19 applies to this Instructional Interactive eBooks process as well.

According to an embodiment of the present invention, the Account management methods for computing revenue splits on eBooks and buying credits through the Payment gateway apply to this Instructional Interactive eBooks as well.

Benefits to Licensees of Invention

The invention will benefit home cooks, professional chefs, and a multitude of operators for for-profit or non-for-profit endeavors. The following paragraphs outline some of the specific advantages.

Chefs and home cooks who feel they have a special culinary gift, experience, or expertise in ethnic or regional cuisine can benefit financially, by using the services of one of the licensees of this invention, by creating and selling their cookbooks online or make them available for download to eBook readers, for instance Apple iPad®, through their respective online stores. The advantage over other traditional forms of cookbook publishing is the simplicity of the process, much higher revenue share, the immediacy of the medium and its multi-media capabilities with pictures, video, sound, and interactivity through software algorithms to adapt content to personal profile.

A group of home chefs could unite as a non-profit organization to provide and distribute cookbooks with detailed nutritional info for schools, camps, and church programs providing meals as part of their activities.

Nutritional departments of clinics and universities could implement some of the methods of the invention to let, for instance, dieticians or nutritionists for their patients, or parents for their college bound children, create, share, and/or monitor online meal plans that meet specific criteria.

Food operators, restaurants or restaurant chains could implement methods of the invention to let users see online the nutrition facts of their recipes or meals before or during patron's visit. Or give users the ability to modify recipes and meals online, that meet specific nutritional values, and to be picked up or served later at the operator's location, or for delivery.

More simply, the same operators could input their recipes through a web site or mobile app and then print out the recipes' nutritional information and food group servings to include as part of the restaurant menu.

Online publications, magazines, or other web sites could implement the methods of this invention to augment the functionality of their own web site and mobile apps, for computing calorie, nutrients values and food group servings of user's own recipes, plus allow them to create eBooks using user's own recipes.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented method for authoring and publishing interactive publications, said method comprising:
creating, at an application server, a repository,
wherein said repository is associated with a primary user chef,
wherein said repository is configured to receive recipes;
sending, from said application server, invites to one or more chefs,
wherein said invite is associated with said repository;
receiving, at said application server, one or more invitation acceptance from said one or more chefs,
wherein said invitation acceptance is related to said invite,
wherein said one or more chefs accepting said invitation for a group of one or more contributing chefs;
receiving, at said application server, one or more recipes from said primary user chef and said one or more contributing chefs;
storing, at said application server, said one or more recipes in said repository;
sorting, at said application server, said one or more recipes, based at least in part on input from said primary user chef and said one or more contributing chefs;
receiving, at said application server, one or more directives from said primary user chef; and
generating, at said application server, a publication containing said one or more recipes and based at least in part on said one or more directives.

2. The method of claim 1, wherein at least one of said one or more directives is comprised of a cover page template.

3. The method of claim 1, wherein at least one of said one or more directives is comprised of a table of content template.

4. The method of claim 1, wherein at least one of said one or more directives is comprised of a recipe page template.

5. The method of claim 1, wherein said publication is an eBook.

6. The method of claim 1, further comprising the steps of:
computing, at said application server, caloric and nutritional information for said one or more recipes; and
storing said caloric and nutritional information in said repository.

7. The method of claim 1, further comprising the steps of:
computing, at said application server, food group information for said one or more recipes; and
storing said food group information in said repository.

8. The method of claim 1, further comprising the steps of:
computing, at said application server, caloric and nutritional information for said one or more recipes;
storing said caloric and nutritional information in said repository;
computing, at said application server, food group information for said one or more recipes;
storing said food group information in said repository;
computing, at said application server, a rating based at least in part on said caloric and nutritional information and said food group information; and
storing said rating in said repository.

9. The method of claim 6, wherein said publication is comprised of caloric and nutritional information for said one or more recipes.

10. The method of claim 1, wherein said publication is comprised of one or more forms of multimedia content.

11. The method of claim 1 wherein a viewer of said publication can personalize said one or more recipes on a viewing device by changing one or more recipe variables.

12. A system for authoring and publishing interactive publications, said system comprising:
a repository component,
wherein said repository component is configured to receive and store one or more recipes,
wherein said repository component is associated with a primary user chef;
an invitation component,
wherein said invitation component is configured to send invitations to one or more chefs,
wherein said invitation component is configured to receive invitation acceptances from said one or more chefs,
wherein said invitation component is communicatively connected to said repository component;
a directive component,
wherein said directive component is configured to receive one or more directives from said primary user chef,
wherein said directive component is communicatively connected to said repository component; and
a publication component,
wherein said publication component is configured to receive said one or more directives from said directive component,
wherein said publication component is further configured to generate a publication based at least in part on said one or more directives,
wherein said publication component is communicatively connected to said repository component.

13. The system of claim 12, wherein at least one of said one or more directives is comprised of a layout template.

14. The system of claim 12, wherein said publication is an eBook.

15. The system of claim 12, further comprised of:
a caloric and nutritional information component,
wherein said caloric and nutritional information component is configured to compute caloric and nutritional information for said one or more recipes,
wherein said caloric and nutritional information component is communicatively connected to said repository.

16. The system of claim 12, further comprised of:
a food group information component,
wherein said food group information component is configured to compute food group information for said one or more recipes,
wherein said food group information component is communicatively connected to said repository.

17. The system of claim 16, wherein said publication is comprised of caloric and nutritional information for said one or more recipes.

18. The system of claim 12, further comprised of:
a caloric and nutritional information component,
wherein said caloric and nutritional information component is configured to compute caloric and nutritional information for said one or more recipes,
wherein said caloric and nutritional information component is communicatively connected to said repository;
a food group information component,
wherein said food group information component is configured to compute food group information for said one or more recipes,
wherein said food group information component is communicatively connected to said repository and said caloric and nutritional information component; and
a rating component,
wherein said rating component is configured to compute a rating,
wherein said rating is based in part on said food group information and said caloric and nutritional information,
wherein said rating component is communicatively connected to said repository, said caloric and nutritional information component and said food group information component.

19. The system of claim 11, wherein said publication is comprised of one or more forms of multimedia content.

20. A computer implemented method for authoring and publishing interactive publications, said method comprising:
creating, at an application server, a repository,
wherein said repository is associated with a primary user,
wherein said repository is configured to receive content;
sending, from said application server, invites to one or more secondary users,
wherein said invite is associated with said repository;
receiving, at said application server, one or more invitation acceptance from said one or more secondary users,
wherein said invitation acceptance is related to said invite,
wherein said one or more secondary users accepting said invitation for a group of one or more contributing secondary users;
receiving, at said application server, one or more pieces of content from said primary user and said one or more contributing secondary users;
storing, at said application server, said one or more pieces of content in said repository;
sorting, at said application server, said one or more pieces of content, based at least in part on input from said primary user and said one or more contributing secondary users;
receiving, at said application server, one or more directives from said primary user; and
generating, at said application server, a publication containing said one or more pieces of content and based at least in part on said one or more directives.
